(19) United States
(12) Patent Application Publication
(10) Pub. No.: US 2026/0214724 A1
(43) Pub. Date: Jul. 23, 2026

(54) DATA PROCESSING METHOD AND APPARATUS

(71) Applicant: HUAWEI TECHNOLOGIES CO., LTD., Shenzhen (CN)

(72) Inventors: Mingyu ZHAO, Shanghai (CN); Xueqiang YAN, Shanghai (CN); Yan XI, Shanghai (CN); Zhe LIU, Shanghai (CN)

(21) Appl. No.: 19/180,811

(22) Filed: Apr. 16, 2025

Related U.S. Application Data
(63) Continuation of application No. PCT/CN2022/126184, filed on Oct. 19, 2022.

(51) Int. Cl. H04W 76/10; H04W 4/50; H04W 40/24

(52) U.S. Cl. CPC H04W 76/10; H04W 4/50; H04W 40/24

(57) ABSTRACT

This application provides a data processing method and an apparatus. In the data processing method, a first device receives a service requirement, and sends a first function configuration of each second device in a data pipeline, where the data pipeline is a data pipeline established for supporting the service requirement; the first function configuration of each second device includes an identifier of a data business, an identifier of the data pipeline, and a first data processing operation; and the first data processing operation is a data processing operation that needs to be performed by each second device in the data pipeline, and the data business is determined based on the service requirement. The first device establishes the data pipeline supporting the service requirement, and configures, for each second device in the data pipeline, the first data processing operation that needs to be performed by the second device.

### CROSS-REFERENCE TO RELATED APPLICATION

This application is a continuation of International Application No. PCT/CN2022/126184, filed on Oct. 19, 2022, the disclosure of which is hereby incorporated by reference in its entirety.

### TECHNICAL FIELD

This application relates to the field of communication technologies, and in particular, to a data processing method and an apparatus.

### BACKGROUND

To promote data analysis and value mining, an artificial intelligence (artificial intelligence, AI) architecture is proposed for data processing. When the AI architecture is used for data processing, an access network device first transmits all data back to a core network, aggregates the data from the core network to a cloud, performs operations such as preprocessing, storage, and analysis on the data by using a network data analytics function (network data analysis function, NWDAF) in the AI architecture, and then returns an analysis result to a data analysis requester.

However, to ensure security and privacy requirements of some data (such as sensing data) and reduce a processing delay, a transmission bandwidth, and the like of the data, the data will be independently processed by a network node in the future.

Therefore, how the network node independently implements data processing is still an urgent problem to be resolved currently.

### SUMMARY

Embodiments of this application provide a data processing method and an apparatus, to help reduce a processing delay and a transmission bandwidth of data, and protect data security and privacy.

According to a first aspect, an embodiment of this application provides a data processing method. The data processing method in this aspect is described from a side of a first device (which may be applied to a device or a chip of the first device). In the method, a first device receives a service requirement. The first device sends a first function configuration of each second device in a data pipeline.

The data pipeline is a data pipeline established for supporting the service requirement, the first function configuration of each second device includes an identifier of a data business, an identifier of the data pipeline, and a first data processing operation. The first data processing operation is a data processing operation that needs to be performed by the second device in the data pipeline, and the data business is determined based on the service requirement.

It can be learned that the first device establishes the data pipeline supporting the service requirement, and configures, for each second device in the data pipeline, the first data processing operation that needs to be performed by the second device in the data pipeline. This helps each second device in the data pipeline perform data processing when the service requirement is met, and further helps reduce a processing delay and a transmission bandwidth for data processing, and protect data security and privacy.

In an optional implementation, the first function configuration of each second device further includes one or more addresses, and an output of each second device is input of one or more devices at the one or more addresses corresponding to the second device.

It can be learned that the one or more addresses in the first function configuration of each second device are next-hop addresses of the second device. This manner helps each second device forward, to the device with the one or more addresses, data obtained by performing the first data processing operation, further helps the device with the one or more addresses perform first data processing on the received data, and further helps the second devices in the data pipeline sequentially perform data processing on the data including the identifier of the data business.

In an optional implementation, the first device may further receive second data processing operations supported by a plurality of second devices, and determine, from a second data processing operation supported by each second device, the data processing operation that needs to be performed by each second device in the data pipeline for the service requirement.

In an optional implementation, the first device may further send a second function configuration to a third device, where the second function configuration includes a third data processing operation. The third device is any second device in the data pipeline. The third data processing operation is a data processing operation in the first data processing operation, or is a data processing operation other than the first data processing operation.

When the third data processing operation is the data processing operation in the first data processing operation, this manner helps the third device delete the third data processing operation in the first data processing operation. When the third data processing operation is the data processing operation other than the first data processing operation, this manner helps the third device add the third data processing operation based on the first data processing operation.

It can be learned that, in this implementation, the third device dynamically updates, based on the third data processing operation, the data processing operation that currently needs to be performed in the data pipeline.

According to a second aspect, an embodiment of this application further provides a data processing method. The data processing method in this aspect corresponds to the data processing method in the first aspect. The data processing method in this aspect is described from a side of a second device (which may be applied to a device or a chip of the second device). In the method, a second device receives a first function configuration, where the first function configuration includes an identifier of a data business, an identifier of a data pipeline, and a first data processing operation, the data pipeline is a data pipeline established for supporting a service requirement, the first data processing operation is a data processing operation that needs to be performed by the second device in the data pipeline, and the data business is determined based on the service requirement. The second device receives first data, and performs the first data processing operation on the first data when determining that the first data includes the identifier of the data business and the identifier of the data pipeline.

It can be learned that, when determining that the received first data includes the identifier of the data business and the identifier of the data pipeline, the second device performs, on the first data, the first data processing operation that needs to be performed by the second device in the data pipeline corresponding to the identifier of the data pipeline. Therefore, the second device can complete data processing on the first data when the service requirement is met. This helps reduce a processing delay and a transmission bandwidth of the first data, and protect data security and privacy.

In an optional implementation, the first function configuration further includes one or more addresses, and an output of the second device is input of one or more devices at the one or more addresses.

It can be learned that the one or more addresses are next-hop addresses of the second device. In this manner, the second device may further send, to the device with the one or more addresses, data obtained by performing the first data processing operation, to complete forwarding of the data obtained by performing the first data processing operation. This manner helps the devices at the one or more addresses perform data processing on the first data, and further helps the second devices in the data pipeline sequentially perform data processing on the data including the identifier of the data business.

In an optional implementation, the second device may further send, to a first device, a second data processing operation supported by the second device, where the first data processing operation of the second device is the data processing operation that is in the second data processing operation supported by the second device and that needs to be performed by the second device in the data pipeline for the service requirement.

In an optional implementation, the second device may further receive a second function configuration, where the second function configuration includes a third data processing operation, and the third data processing operation is a data processing operation in the first data processing operation, or is a data processing operation other than the first data processing operation. The second device updates, based on the third data processing operation, the data processing operation that needs to be performed in the data pipeline.

When the third data processing operation is the data processing operation in the first data processing operation, that the second device updates, based on the third data processing operation, the data processing operation that needs to be performed in the data pipeline means to delete the third data processing operation in the first data processing operation. When the third data processing operation is the data processing operation other than the first data processing operation, that the second device updates, based on the third data processing operation, the data processing operation that needs to be performed in the data pipeline means to add the third data processing operation based on the first data processing operation.

It can be learned that, in this manner, the second device can dynamically update, based on the second function configuration, the data processing operation that needs to be performed in the data pipeline.

According to a third aspect, an embodiment of this application further provides a data processing method. The data processing method in this aspect is described from a side of a first device (which may be applied to a device or a chip of the first device). In the method, a first device receives a service requirement. The first device sends a third function configuration of a data pipeline to a fourth device, where the data pipeline is a data pipeline established for supporting the service requirement.

The third function configuration includes a first data processing operation of each second device in the data pipeline, an identifier of the data pipeline, an identifier of a data business, and an address list, and the data business is determined based on the service requirement. The first data processing operation is a data processing operation that needs to be performed by the second device in the data pipeline. The address list includes an address of a second device other than the fourth device in the data pipeline, and the address included in the address list is arranged in a ranking of performing a first data processing operation by the second device other than the fourth device in the data pipeline. The fourth device is a second device serving as an ingress in the data pipeline.

It can be learned that the first device establishes the data pipeline supporting the service requirement, configures, for each second device in the data pipeline, the first data processing operation that needs to be performed by the second device in the data pipeline, and the addresses at which the second devices sequentially perform the first data processing operations in the data pipeline, and sends the configuration to a second device (namely, the fourth device) serving as the ingress in the data pipeline. This helps the fourth device perform, on the data including the identifier of the data business, the first data processing operation corresponding to the fourth device, and forwards processed data to a second device corresponding to a 1^{st} address in the address list, further helps the second devices in the data pipeline sequentially perform, based on the addresses in the address list, data processing on the data including the identifier of the data business, and helps reduce a processing delay and a transmission bandwidth of first data, and protect data security and privacy.

In an optional implementation, the first device may further receive second data processing operations supported by a plurality of second devices, and determine, from a second data processing operation supported by each second device, the data processing operation that needs to be performed by each second device in the data pipeline for the service requirement.

In an optional implementation, the first device may further send a second function configuration to a third device, where the second function configuration includes a third data processing operation, the third device is any second device in the data pipeline, and the third data processing operation is a data processing operation in the first data processing operation, or is a data processing operation other than the first data processing operation.

When the third data processing operation is the data processing operation in the first data processing operation, this manner helps the third device delete the third data processing operation in the first data processing operation. When the third data processing operation is the data processing operation other than the first data processing operation, this manner helps the third device add the third data processing operation based on the first data processing operation.

It can be learned that, in this implementation, the third device dynamically updates, based on the third data processing operation, the data processing operation that currently needs to be performed in the data pipeline.

According to a fourth aspect, an embodiment of this application further provides a data processing method. The data processing method in this aspect corresponds to the data processing method in the third aspect. The data processing method in this aspect is described from a side of a fourth device (which may be applied to a device or a chip of the fourth device). In the method, a fourth device receives a third function configuration of a data pipeline, where the third function configuration includes a first data processing operation of each second device in the data pipeline, an identifier of the data pipeline, an identifier of a data business, and an address list, the data pipeline is a data pipeline established for supporting a service requirement, the first data processing operation is a data processing operation that needs to be performed by the second device in the data pipeline, and the data business is determined based on the service requirement. The address list includes an address of a second device other than the fourth device in the data pipeline, and the address included in the address list is arranged in a ranking of performing a first data processing operation by the second device other than the fourth device in the data pipeline. The fourth device receives first data, and performs a first data processing operation of the fourth device on the first data when determining that the first data includes the identifier of the data business and the identifier of the data pipeline. The fourth device sends, to a fifth device, data obtained by performing the first data processing operation, where the fifth device is a second device corresponding to a 1^{st} address in the address list.

It can be learned that the fourth device serving as an ingress device in the data pipeline receives the third function configuration of the data pipeline, when the received first data includes the identifier of the data business and the identifier of the data pipeline in the third function configuration, performs the first data processing operation of the fourth device on the first data, and forwards, to the next fifth device that is in the data pipeline and that needs to process the first data, the data obtained by performing the first data processing operation. This helps the second devices in the data pipeline sequentially perform data processing on the first data when the service requirement is met, and further helps reduce a processing delay and a transmission bandwidth of the first data, and protect data security and privacy.

In an optional implementation, the fourth device may send, to a first device, a second data processing operation supported by the fourth device, where the first data processing operation of the fourth device is a data processing operation that is in the second data processing operation supported by the fourth device and that needs to be performed by the fourth device in the data pipeline for the service requirement.

In an optional implementation, the fourth device may further receive a second function configuration, where the second function configuration includes a third data processing operation, and the third data processing operation is a data processing operation in the first data processing operation of the fourth device, or is a data processing operation other than the first data processing operation of the fourth device. The fourth device updates, based on the third data processing operation, the data processing operation that needs to be performed in the data pipeline.

When the third data processing operation is the data processing operation in the first data processing operation of the fourth device, that the fourth device updates, based on the third data processing operation, the data processing operation that needs to be performed in the data pipeline means to delete the third data processing operation in the first data processing operation. When the third data processing operation is the data processing operation other than the first data processing operation of the fourth device, that the fourth device updates, based on the third data processing operation, the data processing operation that needs to be performed in the data pipeline means to add the third data processing operation based on the first data processing operation.

It can be learned that, in this manner, the fourth device can dynamically update, based on the third data processing operation, the data processing operation that needs to be performed by the fourth device in the data pipeline.

According to a fifth aspect, an embodiment of this application further provides a data processing method. The data processing method in this aspect is described from a side of a first device (which may be applied to a device or a chip of the first device). In the method, a first device determines a fourth function configuration of each second device. The first device sends the corresponding fourth function configuration to each second device.

The fourth function configuration of each second device includes one or more fourth data processing operations of the second device, and each of the one or more fourth data processing operations is associated with a different data type.

It can be learned that the first device configures, for each second device, the fourth data processing operation associated with the different data type. This helps each second device determine, based on a data type of received data, a data processing operation to be performed on the received data, and further helps reduce a processing delay of the data.

In an optional implementation, the first device may further receive second data processing operations supported by a plurality of second devices, and determine the one or more fourth data processing operations based on the second data operations supported by the plurality of second devices.

In other words, the one or more fourth data processing operations of each second device are selected from the second data processing operation supported by the second device.

According to a sixth aspect, an embodiment of this application further provides a data processing method. The data processing method in this aspect corresponds to the data processing method in the fifth aspect. The data processing method in this aspect is described from a side of a second device (which may be applied to a device or a chip of the second device). In the method, a second device receives a fourth function configuration, where the fourth function configuration includes one or more fourth data processing operations of the second device, and each of the one or more fourth data processing operations is associated with a different data type.

It can be learned that the fourth function configuration received by the second device includes the one or more fourth data processing operations associated with the different data types. This helps the second device determine, based on a data type of received data, a data processing operation that needs to be performed on the received data, and further helps reduce a processing delay of data processing.

In an optional implementation, the second device may further receive second data, and determine a fifth data processing operation based on a data type of the second data and the fourth function configuration. The second device performs the fifth data processing operation on the second data.

It can be learned that the second device may determine, based on the data type of the second data, the fifth data processing operation that needs to be performed on the second data, and perform the fifth data processing operation on the second data, so that the processing delay of data processing can be reduced.

In an optional implementation, the second device may further send, to a first device, a second data processing operation supported by the second device. This helps the first device determine, based on the second data processing operation supported by the second device, the fourth data processing operation associated with the data type.

According to a seventh aspect, this application further provides a communication apparatus. The communication apparatus has some or all functions of implementing any one of the first aspect to the sixth aspect. For example, functions of the communication apparatus may have functions in some or all embodiments according to the first aspect of this application, or may have functions of independently implementing any embodiment of this application. The function may be implemented by hardware, or may be implemented by hardware executing corresponding software. The hardware or the software includes one or more units or modules corresponding to the function.

In a possible design, a structure of the communication apparatus may include a processing unit and a communication unit. The processing unit is configured to support the communication apparatus in performing a corresponding function in the foregoing methods. The communication unit is configured to support signal receiving and sending. The communication apparatus may further include a storage unit. The storage unit is coupled to the processing unit and the communication unit, and configured to store program instructions and data that are necessary for the communication apparatus.

In an implementation, the communication apparatus includes a communication unit and a processing unit. The processing unit is configured to control the communication unit to receive and send data/signaling;
the communication unit is configured to receive a service requirement; and
the communication unit is further configured to send a first function configuration of each second device in a data pipeline.

The data pipeline is a data pipeline established for supporting the service requirement; and
the first function configuration of each second device includes an identifier of a data business, an identifier of the data pipeline, and a first data processing operation, the first data processing operation is a data processing operation that needs to be performed by the second device in the data pipeline, and the data business is determined based on the service requirement.

In addition, for another optional implementation of the communication apparatus in this aspect, refer to the related content of the first aspect. Details are not described herein again.

In another implementation, the communication apparatus includes a communication unit and a processing unit.

The communication unit is configured to receive a first function configuration, where the first function configuration includes an identifier of a data business, an identifier of a data pipeline, and a first data processing operation, the data pipeline is a data pipeline established for supporting a service requirement, and the first data processing operation is a data processing operation that needs to be performed by the second device in the data pipeline;
the communication unit is further configured to receive first data; and
the processing unit is configured to perform the first data processing operation on the first data when determining that the first data includes the identifier of the data business and the identifier of the data pipeline.

In addition, for another optional implementation of the communication apparatus in this aspect, refer to the related content of the second aspect. Details are not described herein again.

In still another implementation, the communication apparatus includes a communication unit and a processing unit. The processing unit is configured to control the communication unit to receive and send data/signaling;
the communication unit is configured to receive a service requirement; and
the communication unit is further configured to send a third function configuration of a data pipeline to a fourth device, where the data pipeline is a data pipeline established for supporting the service requirement;
the third function configuration includes a first data processing operation of each second device in the data pipeline, an identifier of the data pipeline, an identifier of a data business, and an address list, and the data business is determined based on the service requirement;
the first data processing operation is a data processing operation that needs to be performed by the second device in the data pipeline; and
the address list includes an address of a second device other than the fourth device in the data pipeline, addresses included in the address list are arranged in a sequence of performing the first data processing operations by the second devices in the data pipeline, and the fourth device is a second device serving as an ingress in the data pipeline.

In addition, for another optional implementation of the communication apparatus in this aspect, refer to the related content of the third aspect. Details are not described herein again.

In still another implementation, the communication apparatus includes a communication unit and a processing unit.

The communication unit is configured to receive a third function configuration of a data pipeline, where the third function configuration includes a first data processing operation of each second device in the data pipeline, an identifier of the data pipeline, an identifier of a data business, and an address list, the data pipeline is a data pipeline established for supporting a service requirement, and the data business is determined based on the service requirement, where
the first data processing operation is a data processing operation that needs to be performed by the second device in the data pipeline, the address list includes an address of a second device other than a fourth device in the data pipeline, and the address included in the address list is arranged in a ranking of performing a first data processing operation by the second device in the data pipeline;
the communication unit is further configured to receive first data;
the processing unit is configured to perform a first data processing operation of the fourth device on the first data when determining that the first data includes the identifier of the data business and the identifier of the data pipeline; and
the communication unit is further configured to send, to a fifth device, data obtained by performing the first data processing operation, where
the fifth device is a second device corresponding to a 1^{st} address in the address list.

In addition, for another optional implementation of the communication apparatus in this aspect, refer to the related content of the fourth aspect. Details are not described herein again.

In still another implementation, the communication apparatus includes a communication unit and a processing unit.

The processing unit is configured to determine a fourth function configuration of each second device, where the fourth function configuration of each second device includes one or more fourth data processing operations of the second device, and each of the one or more fourth data processing operations is associated with a different data type; and
the communication unit is configured to send the corresponding fourth function configuration to each second device.

In addition, for another optional implementation of the communication apparatus in this aspect, refer to the related content of the fifth aspect. Details are not described herein again.

In still another implementation, the communication apparatus includes a communication unit and a processing unit. The processing unit is configured to control the communication unit to receive and send data/signaling; and
the communication unit is configured to receive a fourth function configuration, where
the fourth function configuration includes one or more fourth data processing operations of the second device, and each of the one or more fourth data processing operations is associated with a different data type.

In addition, for another optional implementation of the communication apparatus in this aspect, refer to the related content of the sixth aspect. Details are not described herein again.

In an example, the communication unit may be a transceiver, the storage unit may be a memory, and the processing unit may be a processor.

In an implementation, the apparatus includes a transceiver and a processor. The processor is configured to control the transceiver to receive and send data/signaling;
the transceiver is configured to receive a service requirement; and
the transceiver is further configured to send a first function configuration of each second device in a data pipeline, where
the data pipeline is a data pipeline established for supporting the service requirement;
the first function configuration of each second device includes an identifier of the data pipeline, an identifier of a data business, and a first data processing operation, the first data processing operation is a data processing operation that needs to be performed by the second device in the data pipeline, and the data business is determined based on the service requirement.

In addition, for another optional implementation of the communication apparatus in this aspect, refer to the related content of the first aspect. Details are not described herein again.

In another implementation, the communication apparatus includes a transceiver and a processor.

The transceiver is configured to receive a first function configuration, where the first function configuration includes an identifier of a data business, an identifier of a data pipeline, and a first data processing operation, the first data processing operation is a data processing operation that needs to be performed by a second device in the data pipeline, the data pipeline is a data pipeline established for supporting a service requirement, and the data business is determined based on the service requirement;
the transceiver is further configured to receive first data; and
the processor is configured to perform the first data processing operation on the first data when determining that the first data includes the identifier of the data business and the identifier of the data pipeline.

In addition, for another optional implementation of the communication apparatus in this aspect, refer to the related content of the second aspect. Details are not described herein again.

In still another implementation, the communication apparatus includes a transceiver and a processor. The processor is configured to control the transceiver to receive and send data/signaling;
the transceiver is configured to receive a service requirement;
the transceiver is further configured to send a third function configuration of a data pipeline to a fourth device, where the data pipeline is a data pipeline established for supporting the service requirement;
the third function configuration includes a first data processing operation of each second device in the data pipeline, an identifier of the data pipeline, an identifier of a data business, and an address list;
the first data processing operation is a data processing operation that needs to be performed by the second device in the data pipeline, and the data business is determined based on the service requirement; and
the address list includes an address of a second device other than the fourth device in the data pipeline, and the address included in the address list is arranged in a ranking of performing a first data processing operation by the second device in the data pipeline, and the fourth device is a second device serving as an ingress in the data pipeline.

In addition, for another optional implementation of the communication apparatus in this aspect, refer to the related content of the third aspect. Details are not described herein again.

In still another implementation, the communication apparatus includes a transceiver and a processor.

The transceiver is configured to receive a third function configuration of a data pipeline, where the third function configuration includes a first data processing operation of each second device in the data pipeline, an identifier of the data pipeline, an identifier of a data business, and an address list;
the data pipeline is a data pipeline established for supporting a service requirement, and the data business is determined based on the service requirement, where
the first data processing operation is a data processing operation that needs to be performed by the second device in the data pipeline, the address list includes an address of a second device other than a fourth device in the data pipeline, and the address included in the address list is arranged in a ranking of performing a first data processing operation by the second device in the data pipeline;
the transceiver is further configured to receive first data;
the processor is configured to perform a first data processing operation of the fourth device on the first data when determining that the first data includes the identifier of the data business and the identifier of the data pipeline; and
the transceiver is further configured to send, to a fifth device, data obtained by performing the first data processing operation, where
the fifth device is a second device corresponding to a 1^{st} address in the address list.

In addition, for another optional implementation of the communication apparatus in this aspect, refer to the related content of the fourth aspect. Details are not described herein again.

In still another implementation, the communication apparatus includes a transceiver and a processor.

The processor is configured to determine a fourth function configuration of each second device, where the fourth function configuration of each second device includes one or more fourth data processing operations of the second device, and each of the one or more fourth data processing operations is associated with a different data type; and
the transceiver is configured to send the corresponding fourth function configuration to each second device.

In addition, for another optional implementation of the communication apparatus in this aspect, refer to the related content of the fifth aspect. Details are not described herein again.

In still another implementation, the communication apparatus includes a transceiver and a processor. The processor is configured to control the transceiver to receive and send data/signaling;
the transceiver is configured to receive a fourth function configuration, where
the fourth function configuration includes one or more fourth data processing operations of the second device, and each of the one or more fourth data processing operations is associated with a different data type.

In addition, for another optional implementation of the communication apparatus in this aspect, refer to the related content of the sixth aspect. Details are not described herein again.

In another implementation, the communication apparatus is a chip or a chip system. The processing unit may also be represented as a processing circuit or a logic circuit. The transmit unit may be an input/output interface, an interface circuit, an output circuit, an input circuit, a pin, a related circuit, or the like on the chip or the chip system.

In an implementation process, the processor may be configured to perform, for example, but not limited to, baseband-related processing, and the transceiver may be configured to perform, for example, but not limited to, radio frequency receiving and sending. The foregoing components may be separately disposed on chips that are independent of each other, or at least some or all of the components may be disposed on a same chip. For example, the processor may be further divided into an analog baseband processor and a digital baseband processor. The analog baseband processor and the transceiver may be integrated on a same chip, and the digital baseband processor may be disposed on an independent chip. With continuous development of an integrated circuit technology, more components may be integrated on a same chip. For example, the digital baseband processor and a plurality of application processors (for example, but not limited to, a graphics processing unit and a multimedia processor) may be integrated on a same chip. Such a chip may be referred to as a system on a chip (System on a Chip, SoC). Whether the components are separately disposed on different chips or integrated and disposed on one or more chips usually depends on a requirement of a product design. Implementation forms of the foregoing components are not limited in embodiments of this application.

According to an eighth aspect, this application further provides a processor, configured to perform the foregoing methods. In a process of performing these methods, a process of sending the foregoing information and a process of receiving the foregoing information in the foregoing methods may be understood as a process of outputting the foregoing information by the processor and a process of receiving the foregoing input information by the processor. When outputting the information, the processor outputs the information to a transceiver, so that the transceiver transmits the information. After the information is output by the processor, other processing may further need to be performed on the information before the information arrives at the transceiver. Similarly, when the processor receives the input information, the transceiver receives the information, and inputs the information to the processor. Further, after the transceiver receives the information, other processing may need to be performed on the information, and then processed information is input to the processor.

Unless otherwise specified, or if operations such as sending and receiving related to the processor do not contradict an actual function or internal logic of the operations in related descriptions, all the operations may be more usually understood as operations such as outputting, receiving, and inputting of the processor, instead of operations such as sending and receiving directly performed by a radio frequency circuit and an antenna.

In an implementation process, the processor may be a processor specially configured to perform these methods, or may be a processor, for example, a general-purpose processor, that executes computer instructions in the memory to perform these methods. The memory may be a non-transitory (non-transitory) memory, for example, a read-only memory (read-only memory, ROM). The memory and the processor may be integrated on a same chip, or may be separately disposed on different chips. A type of the memory and a manner of disposing the memory and the processor are not limited in this embodiment of this application.

According to a ninth aspect, this application further provides a communication system. The system includes one or more network devices and one or more terminal devices. In another possible design, the system may further include another device that interacts with the network device and the terminal device.

According to a tenth aspect, this application provides a computer-readable storage medium, configured to store instructions, and when the instructions are run by a computer, the method according to any one of the first aspect to the sixth aspect is implemented.

According to an eleventh aspect, this application further provides a computer program product including instructions. When the instructions are run on a computer, the method according to any one of the first aspect to the sixth aspect is implemented.

According to a twelfth aspect, this application provides a chip system. The chip system includes a processor and an interface. The interface is configured to obtain a program or instructions, and the processor is configured to invoke the program or the instructions to implement or support a first device in implementing a function in the first aspect, implement or support a second device in implementing a function in the second aspect, implement or support a first device in implementing a function in the third aspect, implement or support a fourth device in implementing a function in the fourth aspect, implement or support a first device in implementing the function in the fifth aspect, or implement or support a second device in implementing the function in the sixth aspect, for example, determining or processing at least one of data and information in the foregoing methods. In a possible design, the chip system further includes a memory. The memory is configured to store program instructions and data that are necessary for a terminal. The chip system may include a chip, or may include a chip and another discrete component.

According to a thirteenth aspect, this application provides a communication apparatus, including a processor, configured to execute a computer program or executable instructions stored in a memory. When the computer program or the executable instructions are executed, the apparatus is enabled to perform the method in the possible implementations of any one of the first aspect to the sixth aspect.

In a possible implementation, the processor and the memory are integrated together.

In another possible implementation, the memory is located outside the communication apparatus.

For beneficial effect of the seventh aspect to the thirteenth aspect, refer to the beneficial effect of the first aspect to the sixth aspect. Details are not described herein again.

### BRIEF DESCRIPTION OF DRAWINGS

FIG. 1 is a diagram of a system architecture according to an embodiment of this application;

FIG. 2 is a diagram of a wireless network according to an embodiment of this application;

FIG. 3 is a diagram of data processing according to an embodiment of this application;

FIG. 4 is a diagram of a data service architecture according to an embodiment of this application;

FIG. 5 is a diagram of an architecture of a data processing method according to an embodiment of this application;

FIG. 6 is a diagram of forwarding data by using a service function chain according to an embodiment of this application;

FIG. 7 is a diagram of interaction of a data processing method according to an embodiment of this application;

FIG. 8 is a diagram of another data service architecture according to an embodiment of this application;

FIG. 9 is a diagram of interaction between a DO/DC and a DA according to an embodiment of this application;

FIG. 10 is another diagram of interaction between a DO/DC and a DA according to an embodiment of this application;

FIG. 11 is still another diagram of interaction between a DO/DC and a DA according to an embodiment of this application;

FIG. 12 is a diagram of still another data service architecture according to an embodiment of this application;

FIG. 13 is yet another diagram of interaction between a DO/DC and a DA according to an embodiment of this application;

FIG. 14 is still yet another diagram of interaction between a DO/DC and a DA according to an embodiment of this application;

FIG. 15 is a further diagram of interaction between a DO/DC and a DA according to an embodiment of this application;

FIG. 16 is a still further diagram of interaction between a DO/DC and a DA according to an embodiment of this application;

FIG. 17 is a diagram of interaction of another data processing method according to an embodiment of this application;

FIG. 18 is a diagram of interaction of still another data processing method according to an embodiment of this application;

FIG. 19 is a diagram of yet another data service architecture according to an embodiment of this application;

FIG. 20 is a diagram of interaction of yet another data processing method according to an embodiment of this application;

FIG. 21 is a diagram of still yet another data service architecture according to an embodiment of this application;

FIG. 22 is a diagram of a structure of a communication apparatus according to an embodiment of this application; and

FIG. 23 is a diagram of a structure of another communication apparatus according to an embodiment of this application.

### DESCRIPTION OF EMBODIMENTS

The following clearly describes technical solutions in embodiments of this application with reference to accompanying drawings in embodiments of this application.

In the specification, the claims, and the accompanying drawings of this application, terms “first”, “second”, and the like are intended to distinguish between different objects but do not describe a particular sequence. “First” and “second” are merely intended for description, and shall not be understood as an indication or implication of relative importance or implicit indication of a quantity of indicated technical features. Therefore, a feature limited by “first” or “second” may explicitly or implicitly include one or more features. In the description of embodiments, unless otherwise specified, “a plurality of” means two or more.

In addition, terms “include”, “have” and any other variants thereof are intended to cover non-exclusive inclusion. For example, a process, a method, a system, a product, or a device that includes a series of steps or units is not limited to the listed steps or units, but optionally further includes an unlisted step or unit, or optionally further includes another inherent step or unit of the process, the method, the product, or the device.

It should be understood that, in this application, “a plurality of” means two or more. A term “and/or” describes only an association relationship between associated objects and indicates that three relationships may exist. For example, “A and/or B” may indicate the following three cases: Only A exists, only B exists, and both A and B exist, where A and B may be singular or plural. A character “/” usually indicates an “or” relationship between the associated objects. Both “when” and “if” mean that corresponding processing is performed in an objective case, but are not intended to limit time. In addition, the terms do not necessarily mean that a determining action is performed during implementation, and do not mean another limitation either.

In embodiments of this application, a word like “example” or “for example” indicates giving an example, an illustration, or a description. Any embodiment or design solution described as an “example” or “for example” in embodiments of this application should not be explained as being more preferred or having more advantages than another embodiment or design solution. Exactly, use of the terms such as “example” or “for example” is intended to present a related concept in a specific manner for ease of understanding.

### 1. Communication System

To better understand a data processing method disclosed in embodiments of this application, a communication system, a wireless network, and a data service architecture to which embodiments of this application are applicable are described.

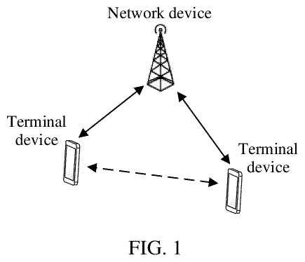

Embodiments of this application may be applied to wireless communication systems such as a 5th generation mobile communication (5th generation mobile communication, 5G) system, a 6th generation mobile communication (6th generation mobile communication, 6G) system, a satellite communication system, and a short-range communication system. A system architecture is shown in FIG. 1. The wireless communication system may include one or more network devices and one or more terminal devices. The wireless communication system may also perform point-to-point communication. For example, a plurality of terminal devices communicate with each other.

It may be understood that the wireless communication system mentioned in embodiments of this application includes but is not limited to a narrowband-internet of things (narrowband-internet of things, NB-IoT) system, a long term evolution (long term evolution, LTE) system, a 5G/6G mobile communication system in three major application scenarios: enhanced mobile broadband (enhanced mobile broadband, eMBB), ultra-reliable and low-latency communication (ultra-reliable and low-latency communication, URLLC), and massive machine-type communication (massive machine-type communication, mMTC), a wireless fidelity (wireless fidelity, Wi-Fi) system, a mobile communication system after 5G, or the like.

In embodiments of this application, the network device is a device having a wireless transceiver function, is configured to communicate with the terminal device, and may be an evolved NodeB (evolved NodeB, eNB or eNodeB) in LTE, a base station in a 5G/6G network, a base station in a future evolved public land mobile network (public land mobile network, PLMN), a broadband network gateway (broadband network gateway, BNG), an aggregation switch, a non-3rd generation partnership project (3rd generation partnership project, 3GPP) access device, or the like. Optionally, the network device in embodiments of this application may include base stations in various forms, for example, a macro base station, a micro base station (also referred to as a small cell), a relay station, an access point, a device for implementing a base station function in the future, an access node in a Wi-Fi system, a transmitting and receiving point (transmitting and receiving point, TRP), a transmitting point (transmitting point, TP), a mobile switching center, and a device that undertakes a base station function in device-to-device (device-to-device, D2D), vehicle-to-everything (vehicle-to-everything, V2X), or machine-to-machine (machine-to-machine, M2M) communication. This is not specifically limited in embodiments of this application.

The network device may communicate and interact with a core network device, to provide a communication service for the terminal device. The core network device is, for example, a device in a 5G network core network (core network, CN). As a bearer network, the core network provides an interface to a data network, provides communication connection, authentication, management, and policy control for a terminal, bears a data business, and the like.

The terminal device in embodiments of this application may include various handheld devices, vehicle-mounted devices, wearable devices, or computing devices having a wireless communication function, or other processing devices connected to a wireless modem. The terminal device may also be referred to as a terminal. The terminal device may also be user equipment (user equipment, UE), an access terminal, a subscriber unit (subscriber unit), a user agent, a cellular phone (cellular phone), a smartphone (smartphone), a wireless data card, a personal digital assistant (personal digital assistant, PDA) computer, a tablet computer, a wireless modem (modem), a handheld device (handset), a laptop computer (laptop computer), a machine-type communication (machine-type communication, MTC) terminal, a communication device carried on a high-altitude aircraft, a wearable device, an uncrewed aerial vehicle, a robot, a terminal in device-to-device (device-to-device, D2D) communication, a terminal in vehicle-to-everything (vehicle-to-everything, V2X), a virtual reality (virtual reality, VR) terminal device, an augmented reality (augmented reality, AR) terminal device, a wireless terminal in industrial control (industrial control), a wireless terminal in self driving (self driving), a wireless terminal in remote medical (remote medical), a wireless terminal in a smart grid (smart grid), a wireless terminal in transportation safety (transportation safety), a wireless terminal in a smart city (smart city), a wireless terminal in a smart home (smart home), a terminal device in a future communication network, or the like. This is not limited in this application.

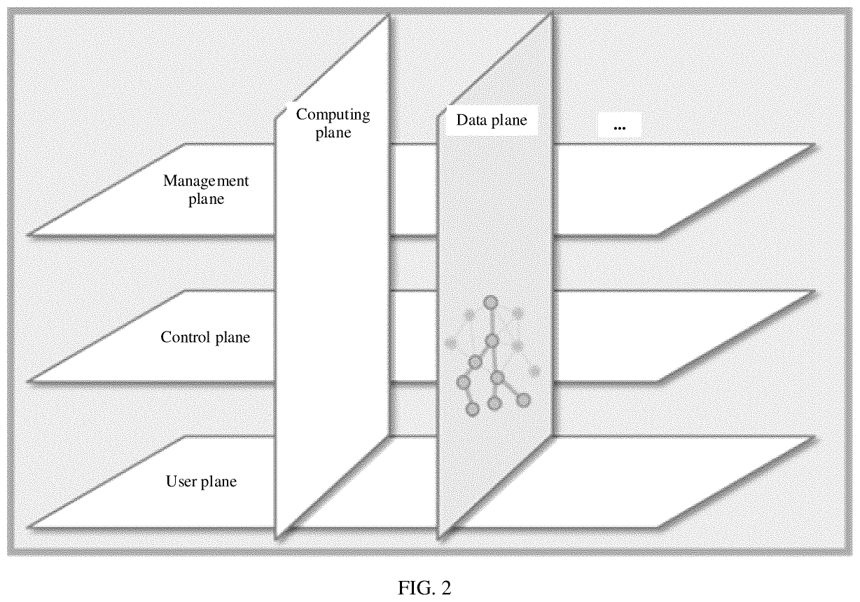

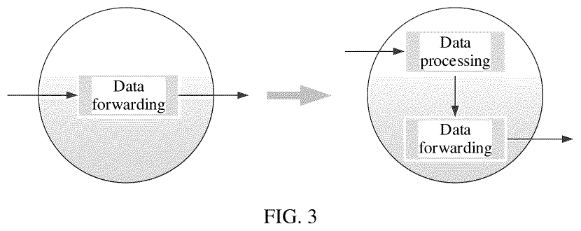

FIG. 2 is a diagram of a wireless network according to an embodiment of this application. As shown in FIG. 2, the wireless network includes a user plane, a control plane, a management plane, a computing plane, and a data plane. The data plane may provide trusted data services for another plane and an application. The another plane may be a producer or a consumer of the data plane. An application plane is usually a consumer of the data plane. However, when the application plane provides data for the data plane, the application plane may also be considered as a producer. As shown in a left figure in FIG. 3, a conventional network node may perform data forwarding, that is, the network node receives data from a previous node, and forwards the received data to a next node. A data plane of the network node in this embodiment of this application may capture or collect data from another plane, perform data processing, and then output processed data to another plane or an application, to implement data as a service (data as a service, DaaS). In other words, the network node in this embodiment of this application may implement data processing and data forwarding shown in a right figure in FIG. 3.

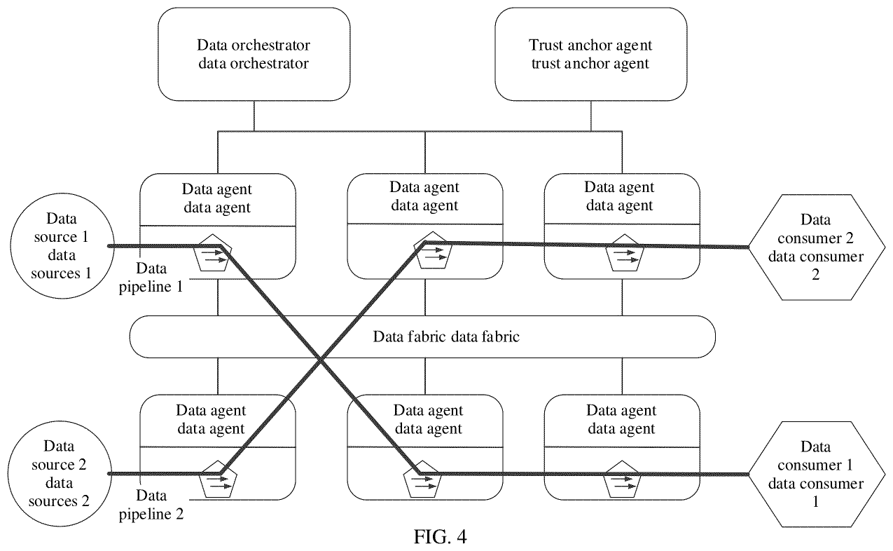

FIG. 4 is a diagram of a data service architecture according to an embodiment of this application. The data service architecture is constructed based on a data plane, and may provide trusted data for intelligent services such as a 6G network and AI. As shown in FIG. 4, the data service architecture includes a data orchestrator (data orchestrator, DO), a trust anchor agent (trust anchor agent, TAA), and a data agent (data agent, DA). A plurality of DAs may be connected to the DO and the TAA through a bus, and the DAs may be connected through connection lines between the DAs and a data fabric (data fabric). The DO may orchestrate and manage a data processing operation of each DA based on an application request. In this way, each DA can provide functions such as data collection, preprocessing, storage, and analysis to implement trusted data services. In addition, the TAA may be used to enable a terminal device to independently control data, implement data trustworthiness, auditability, and traceability, and meet compliance requirements such as the personal information protection law ((personal information protection law, PIPL)/general data protection regulation (general data protection regulation, GDPR)). The DO may enable the DA, through orchestration, to establish a dynamic data pipeline (pipeline). The data pipeline includes a series of data processing units (namely, the DAs) in sequence as required. An output of a previous data processing unit is an input of a next data processing unit.

For example, as shown in FIG. 4, the DO orchestrates each DA, creates a data pipeline 1 based on a data business 1, and creates a data pipeline 2 based on a data business 2. A data source 1 is a data source obtained by a 1^{st} DA in the data pipeline 1 based on the data business 1, and a data source 2 is a data source obtained by a 1^{st} DA in the data pipeline 2 based on the data business 2. The data source 1 reaches a data consumer 1 after being processed by the DAs in the data pipeline 1, and the data source 2 reaches a data consumer 2 after being processed by the DAs in the data pipeline 2.

### 2. Related Concepts

To better understand the data processing method disclosed in embodiments of this application, the related concepts in embodiments of this application are briefly described.

### (1) Data Orchestrator (DO) and Data Agent (DA)

The data orchestrator DO is configured to: receive a data service requirement, select a data agent DA based on the data service requirement, and orchestrate a DA function. Therefore, the DO may dynamically establish an end-to-end (end-to-end, E2E) coverage data transmission network for data, orchestrate data flow between DAs in the data transmission network, and may further feed back a data request response for data to an application.

The data agent DA may be deployed on each network function (network function, NF), radio access network (radio access network, RAN), transmission network (transmission network, TN) node terminal, and operation, administration and maintenance (Operation, Administration and Maintenance, OAM). Alternatively, the DA can be deployed independently.

The DO may establish a dynamic data pipeline (pipeline) through a plurality of DAs. The data pipeline includes a series of DAs in sequence as required. An output of a previous DA is an input of a next DA. In this way, a data flow that can be output from the DA as required from data collection, preprocessing, and storage to application/analysis can be formed, and a service application programming interface (application programming interface, API) can be formed.

### (2) Trust Anchor Agent TAA and Data Storage Function (Data Storage Function, DSF)

The trust anchor agent TAA provides trusted services such as authentication, authorization, and access control (authentication, authorization, access control, AAA), and may further store data that cannot be tampered with, a public key of user equipment or a network device, a short transaction, an index, or important data that cannot be tampered with.

The data storage function DSF is an extension of data agent (DA) storage, can store streaming and batch data, and supports distributed and centralized deployment.

### (3) Service Function Chain (Service Function Chain, SFC)

The service function chain SFC is a technology that provides ordered services for an application layer. The SFC is used to logically connect services on network devices to form an ordered service combination. By adding service chain path information to an original packet, the SFC enables the packet to sequentially pass through service devices along a specified path.

### (4) Data Classification and Data Service

Data is classified into four types: user data, network artificial intelligence (artificial intelligence, AI) data, network data, and internet of things (internet of things, IoT) data considering that a data type, a data source, and a data consumer are orthogonal as much as possible, and the like. The four types of data cover all data in the network, and a data source and a data consumer that correspond to each type of data include but are not limited to those shown in Table 1 below.

TABLE 1
Data sources and data consumers that correspond to different types of data

| Data type | Data source | Data consumer | Remark |
|---|---|---|---|
| User data | Subscription data of a user | Network function, | Personal information |
| | | billing and operation | protection law |
| | | system (billing and | (PIPL)/General data |
| | | operation system, | protection regulation |
| | | BOSS), and third- | (GDPR) compliance and |
| | | party application | privacy protection |
| Network AI | AI model and parameter, | AI/Machine learning | Data security and |
| data | AI metadata (quantity of | (machine learning, | privacy protection |
| | layers, weight, and the | ML) algorithm | |
| | like), and training/test data | | |
| | set | | |
| Network data | UE, NF, location server, | Network analysis | Data security and |
| | internet technology IT | and sensing | privacy protection |
| | system, digital twin | algorithm | |
| | network, RAN node in | | |
| | integrated sensing and | | |
| | communication (integrated | | |
| | sensing and | | |
| | communication, ISAC), | | |
| | and network metadata | | |
| | (type, category, source, | | |
| | quality indicator, | | |
| | association, and location) | | |
| IoT data | Sensor, machine in an IoT, | IoT analysis, and | Compliance |
| | and network device or | autonomous driving | requirement and privacy |
| | facility in an internet of | or intelligent | protection |
| | vehicles | transportation | |
| | | system | |

It can be seen from Table 1 that the user data comes from the subscription data of the user, and may be used in the network function, the BOSS, and the third-party application. The network AI data comes from the AI model and parameter, the AI metadata (the quantity of layers, the weight, and the like), and the training/test data sets, and may be used in the AI/ML, algorithm. The network data comes from the UE, the NF, the location server, the internet technology IT system, the digital twin network, the RAN node in the ISAC, and the network metadata, and may be used in the network analysis and sensing algorithm. The IoT data comes from the sensor, the machine in the IoT, and the network device or facility in the internet of vehicles, and may be used in the IoT analysis, the autonomous driving, or the intelligent transportation system.

In addition, through analysis of various application scenarios and requirements, data services that can be provided by the data plane are classified into eight categories in Table 2 below. As shown in Table 2, the data services that can be provided by the data plane include raw data, data preprocessing, data storage, data privacy and security protection, data sharing/transaction, data source tracing, data analysis, and a data dictionary. The raw data refers to inputting captured or collected raw data to an application like artificial intelligence (AI). The data preprocessing refers to preprocessing services such as data cleaning, filtering, aggregation, and fusion. The data storage refers to providing a centralized or distributed storage service based on a DA/DSF/distributed ledger technology (distributed ledge technology, DLT). The data privacy and security protection refers to providing end-to-end data privacy and security protection technologies. The data sharing/transaction refers to trusted data sharing and transaction. The data source tracing refers to technical compliance with a GDPR/PIPL requirement, a traceable/auditable service, a public key distribution service, and the like. The data analysis refers to performing analysis and mining based on AI, ML, and big data to provide intelligent services. The data dictionary refers to a wireless network feature dataset and a 6G network knowledge graph. It can be learned that the data plane may support a plurality of types of data services.

TABLE 2
Data services

| Data services provided | Service description |
|---|---|
| Raw data | Input the captured or collected raw data to the application like the |
| | AI |
| Data preprocessing | Preprocessing services such as data cleaning, filtering, |
| | aggregation, and fusion |
| Data storage | Provide the centralized or distributed storage service on the |
| | DA/DSF/DLT |
| Data privacy and security | Provide the end-to-end data privacy and security protection |
| protection | technologies |
| Data sharing/transaction | Trusted data sharing and transaction |
| Data source tracing | Technical compliance with the GDPR/PIPL requirement, the |
| | traceable/auditable service, the public key distribution service, and |
| | the like |
| Data services provided | Service description |
| Data analysis | Perform analysis and mining based on the AI, the ML, and the big |
| | data to provide the intelligent services |
| Data dictionary | Wireless network feature dataset and 6G network knowledge |
| | graph |

A current data management and control architecture typically like a network data analytics function (network data analysis function, NWDAF) of the 3rd generation partnership project (3rd generation partnership project, 3GPP) serves a dedicated or specific scenario with data closed in an application/dedicated architecture, resulting in a data silo. A value of data is not fully mined or released due to data positioning restrictions, isolation, and locking. Therefore, data management and control need to be gradually transformed to data services.

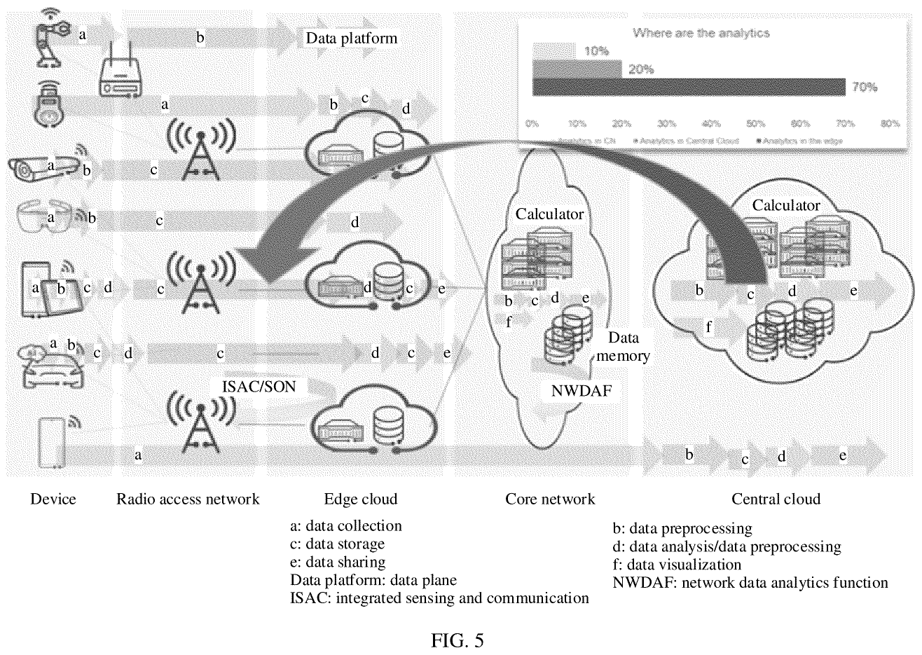

Therefore, new technologies, services, and requirements propose a new manner for data processing, namely, data bearing. Development of AI technologies promotes data analysis and value mining. As shown in FIG. 5, in a current cloud-based AI architecture, when processing data, an access network device first aggregates the data to a cloud over a core network, and the cloud performs operations such as preprocessing, storage, and analysis, and finally returns an analysis result to an access network device.

However, to ensure security of some data (such as sensing data) and reduce a processing delay and the like of the data, the data will be independently processed by a network node in the future. In other words, a traffic model will change in the future, and most traffic will be terminated at a network edge. The existing mode of centralizing traffic to the cloud is no longer applicable.

When being transmitted over a network, a data packet usually needs to pass through various service nodes, so that the network can provide secure, fast, and stable services for a user as planned. These service nodes include a firewall (Firewall, FW), an intrusion prevention system (intrusion prevention system, IPS), an application accelerator, network address translation (network address translation, NAT), and the like. Network traffic needs to pass through these service nodes in a specified sequence required by service logic to implement a required service.

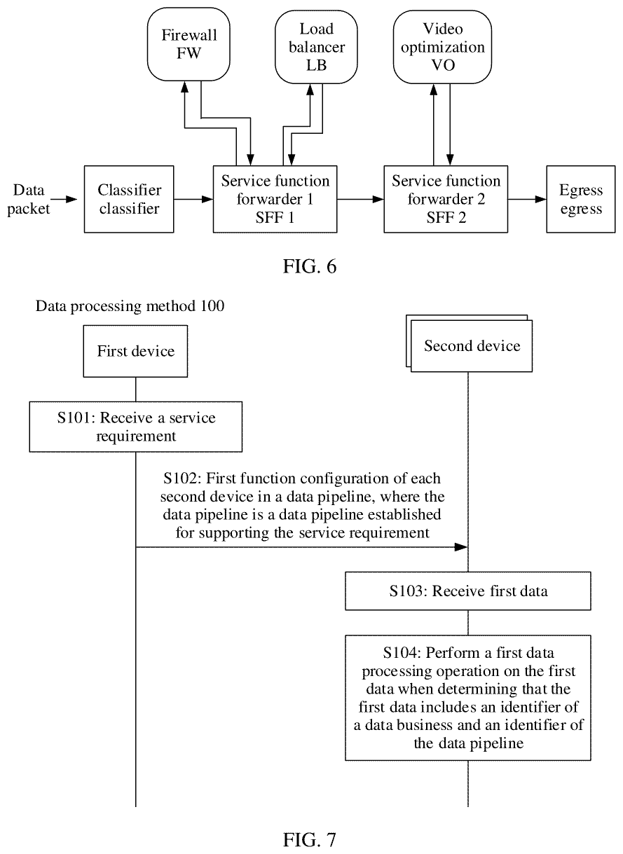

FIG. 6 is a diagram of currently forwarding data by using a service function chain (SFC). As shown in FIG. 6, after a data packet passes through a classifier, is added with a network service header (network service header, NSH), and reaches a service function forwarder (service function forwarder, SFF) 1, it is found that the data packet needs to separately pass through two service functions: a firewall (FW) and a load balancer (LB). The SFF 1 routes the data packet to the FW and the LB for corresponding service processing, and then forwards the data packets to an SFF 2. If the SFF 2 finds that a video optimization (video optimization, VO) service needs to be performed, the SFF 2 routes the received data to the VO for service processing, and finally forwards the data to an egress, and strips the NSH.

It can be learned that, in a data forwarding process, the SFC routes the data to the value-added service node, and the value-added service node processes the data. However, a function of the service function SF is fixed, for example, the firewall FW or network address translation NAT, and a location of the SF is also fixed. Consequently, a flexible requirement of the service cannot be met. In addition, the service node is deployed at a high location, for example, deployed on a cloud. Therefore, a manner in which the data packet is routed to each service node increases a security risk and causes a high transmission delay.

In embodiments of this application, a first device may be a first network device, a second device may be a second network device, the first network device has the data orchestration (DO) function, and the second network device has the data agent (DA) function. Alternatively, the first device is a first data processing unit in a first network device, the second device is the second network device, the first data processing unit has the data orchestration (DO) function, and the second network device has the data agent (DA) function. Alternatively, the first device is the first network device, the second device is a second data processing unit deployed in the second network device, the first network device has the data orchestration (DO) function, and the second data processing unit has the data agent (DA) function. Alternatively, the first device is the first data processing unit deployed in the first network device, the second device is the second data processing unit deployed in the second network device, the first data processing unit has the data orchestration (DO) function, and the second data processing unit has the data agent (DA) function. Alternatively, the first device is a first data processing unit deployed in a third network device, and the second device is a second data processing unit deployed in the third network device. Alternatively, the first device is a DO, and the second device is a DA.

### 3. Data Processing Method 100

An embodiment of this application provides a data processing method 100. FIG. 7 is a diagram of interaction of a data processing method 100. The data processing method 100 includes but is not limited to the following steps.

S101: A first device receives a service requirement.

It may be understood that, after receiving the service requirement, the first device parses the service requirement, and determines a data business for the service requirement. For the service requirement, a type of data that needs to be obtained, a type of data processing to be performed, and the like may be selected based on the data business. For example, for a service requirement 1, the first device determines that the network data in Table 1 needs to be obtained.

In an optional implementation, that a first device receives a service requirement includes:
The first device receives a service requirement from an application or a network service (network service, NS). Correspondingly, the application or the NS sends the service requirement to the first device, so that the first device learns of the service requirement.

In an optional implementation, the first device may further receive a plurality of second data processing operations supported by a plurality of second devices. In other words, the plurality of second devices may report, to the first device, the second data processing operation supported by each second device, so that the first device obtains the second data processing operations supported by the plurality of second devices. This helps the first device establish, based on the second data processing operations supported by the plurality of second devices, a data pipeline that supports the service requirement. The second data processing operation includes but is not limited to one or more of the data services provided in Table 2. The data processing operation may alternatively be understood as the data service.

In an optional implementation, when reporting, to the first device, the second data processing operations supported by the second devices, the plurality of second devices report the second data processing operations based on code information of the supported second data processing operations. For example, the code information of the data processing operation includes eight bits (bits), where four most significant bits of the eight bits indicate first-level code, and four least significant bits indicate second-level code.

For example, the first-level code information of the data processing operation/data service is shown in Table 3 below, and the second-level code information of each data processing operation/data service in Table 3 is shown in Table 4 to Table 11 below.

TABLE 3
First-level code of data processing operations/data services

| | |
|---|---|
| 0000XXXX | Data collection |
| 0001XXXX | Data preprocessing |
| 0010XXXX | Data storage |
| 0011XXXX | Data security and privacy |
| | protection |
| 0100XXXX | Data source tracing |
| 0101XXXX | Data analysis |
| 0110XXXX | Data sharing/transaction |
| 0111XXXX | Data dictionary |
| 1000XXXX | Data synthesis |

TABLE 4
Second-level code of data collection

| | |
|---|---|
| 00000001 | Data collection interval |
| 00000010 | Batch data |
| 00000011 | Streaming data |
| 00000100 | Event report |
| 00000101 | Vtap |

TABLE 5
Second-level code of data preprocessing

| | |
|---|---|
| 00010001 | Data cleaning |
| 00010010 | Data filtering |
| 00010011 | Data fusion |
| 00010100 | Data redundancy |
| | elimination |
| 00010101 | Data aggregation |

TABLE 6
Second-level code of data storage

| | |
|---|---|
| 00100001 | Centralized storage |
| 00100010 | Distributed storage |
| 00100011 | Storage extension |
| 00100100 | On-chain storage |
| 00100101 | — |

TABLE 7
Second-level code of data security and privacy protection

| | |
|---|---|
| 00110001 | Differential privacy |
| 00110010 | Homomorphic encryption |
| 00110011 | Multi-party computation |
| 00110100 | Zero knowledge proof |
| 00110101 | — |

TABLE 8
Second-level code of data source tracing

| | |
|---|---|
| 01000001 | Authentication |
| 01000010 | Authorization |
| 01000011 | Access control |
| 01000100 | Source tracing/Audit |
| 01000101 | — |

TABLE 9
Second-level code of data analysis

| | |
|---|---|
| 01010001 | Big data analysis |
| 01010010 | Model training |
| 01010011 | Model inference |
| 01010100 | Knowledge graph |
| 01010101 | Federated learning |
| 01010101 | — |

TABLE 10
Second-level code of data sharing/transaction

| | |
|---|---|
| 01100001 | Data sharing |
| 01100010 | Data transaction |
| 01100011 | — |
| 01100100 | — |
| 01100101 | — |

TABLE 11
Second-level code of the data dictionary

| | |
|---|---|
| 01110001 | Feature dataset |
| 01110010 | Data format |
| 01110011 | — |
| 01110100 | — |
| 01110101 | — |

It can be learned that the first device may obtain, based on the first-level code and the second-level code of the eight bits in the code information, the second data processing data operation supported by each of the plurality of second devices, so that the first device establishes, based on the second data processing operation supported by each second device, the data pipeline supporting the service requirement, and configures, for each second device in the data pipeline, a first data processing operation that needs to be performed.

It may be understood that the data processing operation in this embodiment of this application includes but is not limited to the data processing operations in Table 3 to Table 11.

Optionally, when reporting the second data processing operation supported by the second devices to the first device, the plurality of second devices may further report location information of the second devices, where the location information may be longitude and latitude information. In this manner, the first device may determine, based on the location information of the plurality of second devices, a second device within a management range of the first device, so that the first device can perform data orchestration on the second device within the management range, that is, configure, for the second device within the management range based on a data service requirement, the first data processing operation that needs to be performed.

For example, information content reported by a second device a to the first device is shown in Table 12. It can be seen from Table 12 that, the information reported by the second device a to the first device includes an identifier and a location of the second device a, and code information of a supported second data processing operation. When the second device a is a DA 1, the identifier of the second device a may be an identity (identity, ID) of the DA 1, namely, DA_ID 1. With reference to Table 3 to Table 11, the first device may learn, based on the code information of the second data processing operation supported by the second device a, that the second data processing operation supported by the second device a includes the data collection-data collection interval, the data preprocessing-data fusion, and the data source tracing-authentication.

TABLE 12
Information content reported by the second device a

| Identifier | Location | Supported second data processing operation |
|---|---|---|
| Identifier a | Longitude and latitude | 00000001, 00010011, and 01000001 |

S102: The first device sends a first function configuration of each second device in the data pipeline, where the data pipeline is a data pipeline established for supporting the service requirement. Correspondingly, each second device receives the first function configuration.

The first function configuration of each second device includes an identifier of the data business, an identifier of the data pipeline, and the first data processing operation. The first data processing operation is a data processing operation that needs to be performed by the second device in the data pipeline, and the data business is determined based on the service requirement.

It may be understood that, after receiving the service requirement, the first device determines the data business corresponding to the service requirement, that is, determines the type of data that needs to be obtained, the type of data processing to be performed, and the like, to establish, based on the second data processing operation supported by each second device and the obtained data type, the data pipeline including the plurality of second devices, and configure, for each second device in the data pipeline, the first data processing operation that needs to be performed in the data pipeline. In other words, the data pipeline is the data pipeline established by the first device to support the service requirement.

It may also be understood that the first device determines, from a second data processing operation supported by each second device, the data processing operation that needs to be performed by each second device in the data pipeline for the service requirement, namely, the first data processing operations.

Therefore, this manner helps the second devices in the data pipeline jointly complete data processing on the obtained data when the service requirement is met. In addition, the first device establishes, based on the service requirement, the data pipeline including the plurality of second devices, so that a flexible requirement of the service can be met.

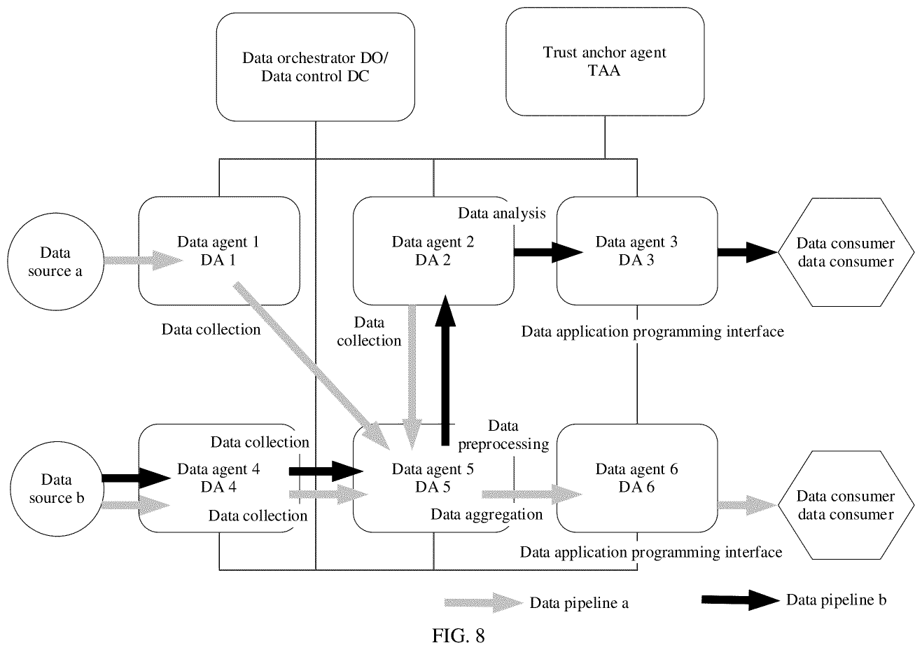

For example, the first device is a DO/data control (data control, DC), the second device is a DA, and the DC may be considered as a processing unit in the DO. A diagram of a data service architecture is shown in FIG. 8. The diagram of the data architecture includes a DO/DC, a TAA, and a plurality of DAs. Service requirements obtained by the DO include a service requirement 1 and a service requirement 2. As shown in FIG. 8, when the first device determines, based on the service requirement 1, that a data service of a data business is data collection->data aggregation->data application programming interface, a data pipeline created by the DO based on the service requirement 1 includes a data pipeline a. The data pipeline a includes a data pipeline 1 including a DA 1, a DA 5, and a DA 6, a data pipeline 2 including a DA 4, the DA 5, and the DA 6, and a data pipeline 3 including a DA 2, the DA 5, and the DA 6. The DO configures first data processing operations that need to be performed by the DA 1, the DA 5, and the DA 6 in the data pipeline 1, configures first data processing operations that need to be performed by the DA 4, the DA 5, and the DA 6 in the data pipeline 2, and configures first data processing operations that need to be performed by the DA 2, the DA 5, and the DA 6 in the data pipeline 3, which are respectively the data collection, the data aggregation, and the data application programming interface. It can be learned that all the DAs in the data pipeline 1, the data pipeline 2, and the data pipeline 3 can jointly complete data processing on source data when the service requirement 1 is met. In FIG. 8, data collected by the DA 1 is a data source (data source) 1, and data collected by the DA 4 is a data source 2.

It may also be understood that the DA 1, the DA 5, and the DA 6 are connected based on requirements of the data collection, the data aggregation, and the data application programming interface, and may form the data pipeline 1 supporting the service requirement 1. Similarly, the DA 4, the DA 5, and the DA 6 are connected based on the requirements of the data collection, the data aggregation, and the data application programming interface, and may also form the data pipeline 2 supporting the service requirement 1. The DA 2, the DA 5, and the DA 6 are connected based on the requirements of the data collection, the data aggregation, and the data application programming interface, and may also form the data pipeline 3 supporting the service requirement 1. In other words, the data pipeline 1, the data pipeline 2, and the data pipeline 3 are all data pipelines established for supporting the service requirement 1.

In conclusion, for a same service requirement, the first device may establish a plurality of different data pipelines based on the second data processing operations supported by the plurality of second devices, and the different data pipelines may include some same second devices.

For example, as shown in FIG. 8, when the first device determines, based on the service requirement 2, that a data service of a data business is data collection->data preprocessing->data analysis->data application programming interface, the DO creates a data pipeline b based on the service requirement 1. The data pipeline b includes the DA 4, the DA 5, the DA 2, and a DA 3, and first data processing operations that need to be performed by the DA 4, the DA 5, the DA 2, and the DA 3 in the data pipeline b are the data collection, the data preprocessing, the data analysis, and the data application programming interface. It may also be understood that the DA 4, the DA 5, the DA 2, and the DA 3 are connected based on requirements of the data collection, the data preprocessing, the data analysis, and the data application programming interface, and may form the data pipeline b supporting the service requirement 2.

It can be learned from the data pipelines established by the DO to support the service requirement 1 and the service requirement 2 that the first device may establish different data pipelines based on different service requirements. It may also be understood that, to support different service requirements, the second devices may be connected as required to form different data pipelines. In addition, a same second device may need to perform different first data processing operations in different data pipelines. It may also be understood that the first data processing operation that needs to be performed, in the data pipeline, by each second device in the data pipeline may be configured by the first device as required. For example, as shown in FIG. 8, the first data processing operation that needs to be performed by the DA 2 in the data pipeline a is the data collection, and the first data processing operation that needs to be performed in the data pipeline b is the data analysis. For another example, as shown in FIG. 8, the first data processing operation that needs to be performed by the DA 5 in the data pipeline a is the data aggregation, and the first data processing operation that needs to be performed in the data pipeline b is the data preprocessing.

It may be understood that the first function configuration of each second device includes the identifier of the data business, the identifier of the data pipeline, and the first data processing operation. The identifier of the data pipeline may be an identity (identity, ID) of the data pipeline (data pipeline), and may be marked by DP_ID. The identifier of the data business may be an identity of the data service (data service) determined based on the service requirement, and may be marked by DS_ID.

For example, the data service determined by the first device based on the service requirement 1 is a data service 1, the data service determined based on the service requirement 2 is a data service 2, the first device is the DO, and the second device is the DA 1. For the service requirement, the first function configuration configured by the DO for the DA 1 may be sent by using configuration entries, and the configuration entries are shown in Table 13.

TABLE 13
First function configuration entries of the DA 1

| | | DA | First data processing | |
|---|---|---|---|---|
| DS ID | DP ID | identifier | operation | Remark |
| DS_ID | DP_ID 1 | DA_ID 1 | 00000010->00010001 | Data collection->data |
| 1 | | | | cleaning |
| DS_ID | DP_ID 2 | DA_ID 1 | 00010010->00110001 | (Received data) |
| 1 | | | | filtering->de-privacy |
| DS_ID | DP_ID 3 | DA_ID 1 | 00010101 | (Received data) aggregation |
| 2 | and DP_ID | | | |
| | 4 | | | |

It can be seen from Table 13 that, for the service requirement 1, the first function configuration configured by the DO for the DA 1 includes the identity of the data service 1, namely, DS_ID 1, the identifiers of the data pipelines created based on the service requirement 1, namely, DP_ID 1 and DP_ID 2, and the code information corresponding to the first data processing that needs to be performed by the DA 1 in DP_ID 1 and DP_ID 2. It can be learned that the DO may establish different data pipelines based on the service requirement 1. The data pipeline includes the data pipeline 1 corresponding to DP_ID 1 and the data pipeline 2 corresponding to DP_ID 2, and both the data pipeline 1 and the data pipeline 2 include the DA 1. The first data processing that needs to be performed by the DA 1 in the data pipeline 1 is the data collection, and data cleaning performed on the captured data. The first data processing operation that needs to be performed by the DA 1 in the data pipeline 2 includes filtering the received data and performing de-privacy on filtered data.

The data pipelines established by the DO based on the service requirement 2 include the data pipeline 3 corresponding to DP_ID 3 and the data pipeline 4 corresponding to DP_ID 4, and both the data pipeline 3 and the data pipeline 4 include the DA 1. The first data processing that needs to be performed by the DA 1 in the data pipeline 3 and the data pipeline 4 is aggregating the received data. Therefore, the first function configuration configured by the DO for the DA 1 further includes the identity of the data service 2, namely, DS_ID 2, DP_ID 3, and DP_ID 4, and the code information corresponding to the first data processing operations that need to be performed by the DA 1 in the data pipeline 3 and the data pipeline 4.

It can be learned that the first device may establish different data pipelines based on different service requirements, the different data pipelines may include a same second device, and the second device needs to perform different first data processing operations in the different data pipelines. The first device may further establish a plurality of different data pipelines based on a same service requirement, the different data pipelines may also include a same second device, and the second device may need to perform a same first data processing operation in the different data pipelines.

In another optional implementation, the first function configuration of each second device may further include one or more addresses, and an output of each second device is input of one or more devices at the one or more addresses corresponding to the second device. In other words, the one or more addresses included in the first function configuration are next-hop addresses of the second device. For example, if a first function configuration a of the second device a includes an address 1 and an address 2, after performing, on the received data, the first data processing operation that needs to be performed in the data pipeline, the second device sends, to a device 1 at the address 1 and a device 2 at the address 2, data obtained by processing the first data. The second device may send, to the device 1 and the device 2 in a unicast or multicast manner, the data obtained by processing the first data.

For example, the first device is the DO, the second device is the DA 1, and first function configuration entries configured by the DO for the DA 1 are shown in Table 14. Compared with Table 13, in Table 14, the DO further configures one or more addresses for a next hop of the DA 1. For example, for the data pipeline 1 corresponding to DP_ID 1, the first function configuration includes the address 1 and the address 2. After performing data collection and data cleaning in the data pipeline 1, the DA 1 sends data obtained through the data cleaning to the device 1 at the address 1 and the device 2 at the address 2. For another example, for the data pipeline 2 corresponding to DP_ID 2, the first function configuration includes an address 3. After performing filtering and de-privacy operations in the data pipeline 2, the DA 1 sends data obtained through de-privacy to a device 3 at the address 3. For another example, for the data pipeline 3 and the data pipeline 4 respectively corresponding to DP_ID 3 and DP_ID 4, the first function configuration includes an address 4. After performing data aggregation in the data pipeline 3 or the data pipeline 4, the DA 1 sends aggregated data to a device 4 at the address 4.

TABLE 14
First function configuration entries of the DA 1

| | | | One or | | |
|---|---|---|---|---|---|
| DS | | DA | more | First data processing | |
| ID | DP ID | identifier | addresses | operation | Remark |
| DS_ID | DP_ID 1 | DA_ID 1 | Address 1 | 00000010->00010001 | Data collection->data |
| 1 | | | and | | cleaning |
| | | | address 2 | | |
| DS_ID | DP_ID 2 | DA_ID 1 | Address 3 | 00010010->00110001 | (Received data) |
| 1 | | | | | filtering->de-privacy |
| DS_ID | DP_ID 3 | DA_ID 1 | Address 4 | 00010101 | (Received data) |
| 2 | and | | | | aggregation |
| | DP_ID 4 | | | | |

It can be learned that, in this implementation, the second devices send, to the devices at the one or more addresses, the data obtained by performing the first data processing operation, and the second devices in the data pipeline sequentially complete data processing on the data obtained for the service requirement, to reduce a processing delay and a transmission bandwidth for data processing, and protect data security and privacy.

In an optional implementation, the first device sends, to each second device in the data pipeline, the first function configuration corresponding to each second device, so that each second device in the data pipeline learns of the first data processing operation that needs to be performed by the second device in the data pipeline.

Optionally, the first device may further send, to a data application or a network service, an identifier of a second device serving as an ingress in the data pipeline, so that the data application or the network service learns of the second device that is in the data pipeline and that collects the data for the service requirement. Therefore, the data application or the network service sends the data for the service requirement to the second device serving as the ingress in the data pipeline, so that the data enters the data pipeline, and the second device serving as the ingress in the data pipeline performs the first data processing operation on the data.

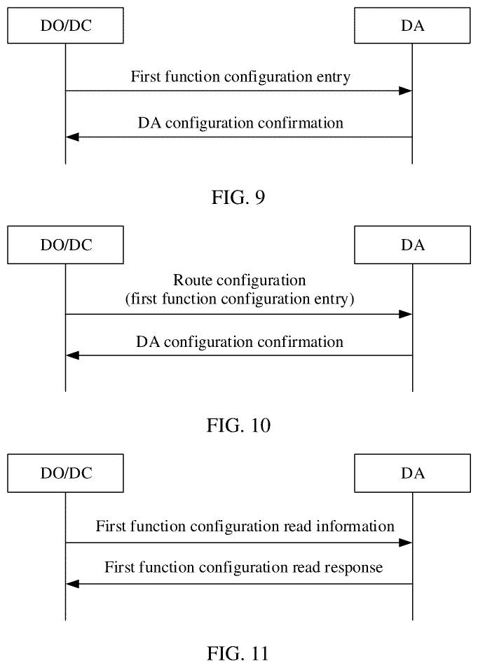

For example, when the first device is the DO/DC, the second device is the DA, and the first function configuration includes the identifier of the data business, the identifier of the data pipeline, and the first data processing operation, a diagram in which the DO/DC sends the first function configuration to the DA may be shown in FIG. 9. As shown in FIG. 9, the DO/DC separately sends first function configuration entry to the DA, and the DA may feed back DA configuration confirmation to the DO/DC, where the DA configuration confirmation is used to confirm that the first function configuration entry is received.

For example, when the first device is the DO/DC, the second device is the DA, and the first function configuration includes the identifier of the data business, the identifier of the data pipeline, the first data processing operation, and an address list including an address of a second device other than the DA serving as the ingress in the data pipeline, a diagram in which the DO/DC sends the first function configuration to the DA may be shown in FIG. 10. As shown in FIG. 10, the DO/DC sends first function configuration entry to the DA with reference to a route configuration, and the DA may also feed back DA configuration confirmation to the DO/DC.

Optionally, the first device may further send first function configuration read information to each second device, so that each second device obtains the first function configuration. After reading the first function configuration, each second device may further feed back a first function configuration read response to the first device, to notify the first device that the second device reads the first function configuration. For example, as shown in FIG. 11, the first device is the DO/DC, the second device is the DA, and the DO/DC sends the first function configuration read information to the DA. After reading the first function configuration based on the first function configuration read information, the DA sends the first function configuration read response to the DO/DC.

S103: The second device receives first data.

The second device may be any one of the plurality of second devices in the data pipeline.

S104: The second device performs the first data processing operation on the first data when determining that the first data includes the identifier of the data business and the identifier of the data pipeline.

It may be understood that, that the first data includes the identifier of the data business and the identifier of the data pipeline may mean that a data header of the first data carries the identifier of the data business and the identifier of the data pipeline.

When determining that the first data includes the identifier of the data business, the second device may determine that the first data is the data source or data obtained by processing the data source. When the second device determines that the first data includes the identifier of the data pipeline, the second device may determine that the data pipeline corresponding to the identifier of the data pipeline is the data pipeline established for supporting the service requirement, so that the second device may determine the first data processing operation that needs to be performed on the first data in the data pipeline. Therefore, when determining that the first data includes the identifier of the data business and the identifier of the data pipeline, the second device performs the first data processing operation on the first data, to complete data processing that needs to be performed by the second device on the first data in the data pipeline.

It may be understood that, when the plurality of data pipelines are created for the first data based on the service requirement, that the first data includes the identifier of the data pipeline may mean that the first data includes an identifier of each of the plurality of data pipelines, or may mean that the first data includes an identifier of any one of the plurality of data pipelines, or the identifier of the data pipeline may be an identifier of a data pipeline newly created by a previous second device of the second device based on the service requirement.

For example, as shown in FIG. 8, the data pipelines created by the DO based on the service requirement 1 include the data pipeline 1, the data pipeline 2, and the data pipeline 3, and the second device is the DA 6. When the first data received by the DA 6 includes identifiers of all of the data pipeline 1, the data pipeline 2, and the data pipeline 3, the DA 6 performs data application programming interface processing on the first data. Alternatively, when the first data received by the DA 6 includes an identifier of any one of the data pipeline 1, the data pipeline 2, and the data pipeline 3, the DA 6 performs data application programming interface processing on the first data. Alternatively, after receiving the data from the DA 1, the DA 4, and the DA 2, the DA 5 aggregates the data, creates a new data pipeline 4 based on the service requirement 1, and carries an identifier of the data pipeline 4 in data obtained through data aggregation. In this case, when the data received by the DA 6 includes the identifier of the data pipeline 4, the DA 6 performs data application programming interface processing on the received data.

In an optional implementation, when the first function configuration further includes the one or more addresses, the second device may further send, to the device corresponding to the one or more addresses, data obtained by processing the first data, that is, the output of the second device is the input of the device corresponding to the one or more addresses. When the first function configuration includes the plurality of addresses, the second device may implement data multicast.

Optionally, the next-hop address of the second device may alternatively be separately delivered by the first device, that is, the next-hop address of the second device is not carried in the first function configuration. In both the foregoing two manners, the second devices in the data pipeline can sequentially complete data processing on the data obtained based on the same service requirement, thereby reducing the processing delay of data processing.

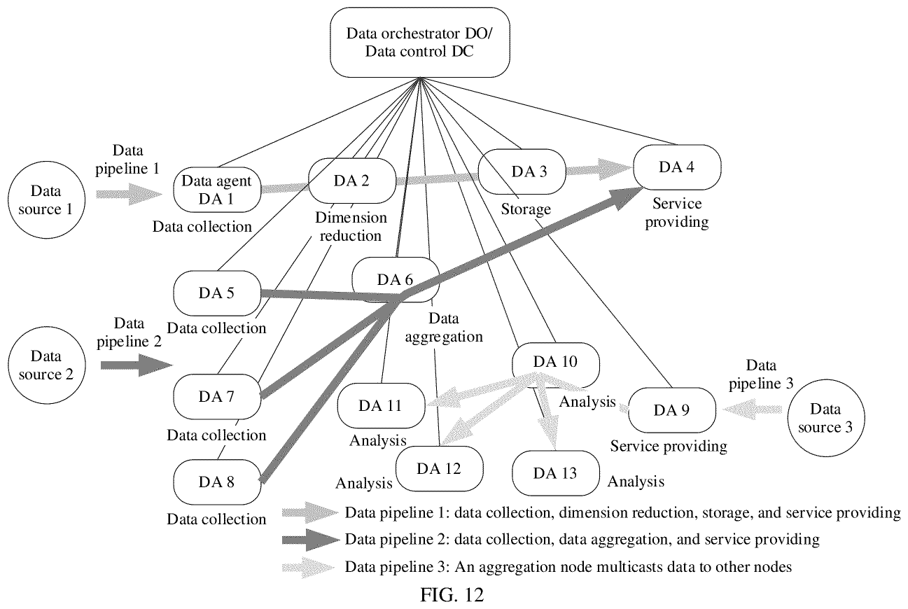

For example, as shown in FIG. 12, the first device is a DO/DC, the second device is a DA, a data pipeline established by the DO based on a service requirement 1 is a data pipeline 1, a data pipeline established based on a service requirement 2 is a data pipeline 2, and a data pipeline established based on a service requirement 3 is a data pipeline 3. The data pipeline 1 includes a DA 1, a DA 2, a DA 3, and a DA 4. The DA 1, the DA 2, the DA 3, and the DA 4 sequentially perform operations of data collection, dimension reduction, storage, and service providing in the data pipeline 1, to meet a service requirement of data 1. The data pipeline 2 includes a DA 5, a DA 6, and the DA 4, or includes a DA 7, the DA 6, and the DA 4, or includes a DA 8, the DA 6, and the DA 4. The DA 5, the DA 6, and the DA 4, or the DA 7, the DA 6, and the DA 4, or the DA 8, the DA 6, and the DA 4 sequentially perform data collection, data aggregation, and service providing in the data pipeline 2, to meet a service requirement of data 2. The data pipeline 3 includes a DA 9, a DA 10, a DA 11, a DA 12, and a DA 13. The DA 9 provides a service in the data pipeline 3, and the DA 10 serves as an aggregation node in the data pipeline 3 and performs multicast to the DA 11, the DA 12, and the DA 13, to implement multicast of data 3.

It can be learned that the second devices in the data pipeline may sequentially perform, in an arrangement sequence in the data pipeline, the first data processing operations that need to be performed in the data pipeline, and may forward, to a next-hop second device, data obtained by performing the first data processing operation. In this manner, each second device in the data pipeline can not only complete data processing, but also complete data forwarding, thereby reducing the processing delay of data processing.

In an optional implementation, the first device may further send a second function configuration to a third device when the service requirement changes, where the second function configuration includes a third data processing operation. The third device is any second device in the data pipeline, and the third data processing operation is a data processing operation in the first data processing operation, or is a processing operation other than the first data processing operation. Therefore, the second device may receive the second function configuration, and update, based on the third data processing operation in the second function configuration, the data processing operation that needs to be performed in the data pipeline.

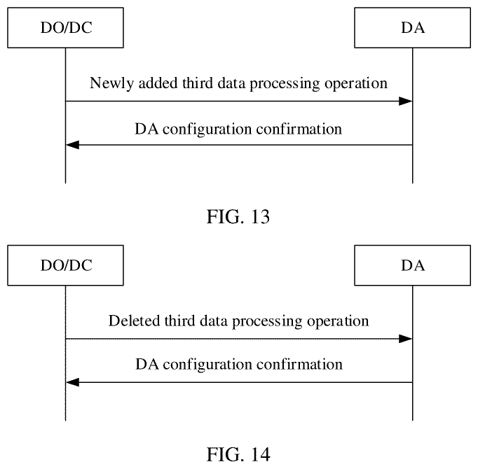

For example, when the first device is the DO/DC, the second device is the DA, and the third data processing operation is the data processing operation other than the first data processing operation, that the DO/DC sends the second function configuration to the DA is pushing a new third data processing operation to the DA. As shown in FIG. 13, the DO/DC sends, to the DA, the third data processing operation to be newly added, and the DA may send confirmation to the DO/DC to confirm that the third data processing operation that needs to be newly added is received.

For example, when the first device is the DO/DC, the second device is the DA, and the third data processing operation is the data processing operation in the first data processing operation, that the DO/DC sends the second function configuration to the DA is delivering, to the DA, the third data processing operation to be deleted. As shown in FIG. 14, the DO/DC delivers, to the DA, the third data processing operation to be deleted, and the DA may send confirmation to the DO/DC to confirm that the third data processing operation to be deleted is received.

Therefore, when the third data processing operation is the data processing operation in the first data processing operation, that the second device updates, based on the third data processing operation, the data processing operation that needs to be performed in the data pipeline may mean: The second device deletes the third data processing operation in the first data processing operation, so that the second device does not need to perform the third data processing operation when performing the data processing operation on the first data in the data pipeline. When the third data processing operation is the data processing operation other than the first data processing operation, that the second device updates, based on the third data processing operation, the data processing operation that needs to be performed in the data pipeline may mean: The second device adds the third data processing operation based on the first data processing operation, so that the second device needs to perform the first data processing operation and the third data processing operation when performing the data processing operation on the first data in the data pipeline.

For example, if the first data processing operation includes data collection and data cleaning, and the third data processing operation is data cleaning, the second device determines that the data processing operation that needs to be performed on the first data in the data pipeline is data collection. For another example, if the first data processing operation includes data collection and data cleaning, and the third data processing operation is data dimension reduction, the second device determines that the data processing operation that needs to be performed on the first data in the data pipeline includes data collection, data cleaning, and data dimension reduction. Therefore, the second-level code of data preprocessing in Table 5 may be updated to second-level code shown in Table 15 below.

TABLE 15
Second-level code of data preprocessing

| | |
|---|---|
| 00010001 | Data cleaning |
| 00010010 | Data filtering |
| 00010011 | Data fusion |
| 00010100 | Data redundancy elimination |
| 00010101 | Data aggregation |
| 00010110 | Data dimension reduction |

Compared with Table 5, in Table 15, the second-level code of data dimension reduction is newly added to the second-level code of data preprocessing. Therefore, the first device may indicate the newly added data dimension reduction to the third device by using the code information “00010110”.

It can be learned that the first device may dynamically notify, based on the service requirement, the second device of the third data processing operation that needs to be updated, so that the second device dynamically updates, based on the received third data processing operation, the data processing operation that needs to be performed on the first data in the data pipeline, thereby improving reliability of data processing.

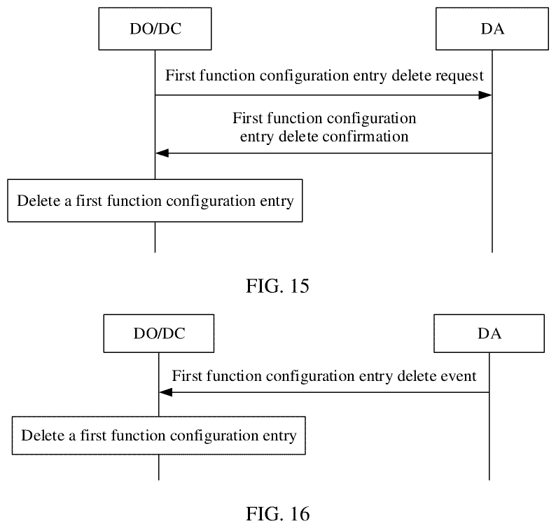

Optionally, after confirming that the second device completes the first data processing operation on the first data, the first device may further delete the first function configuration for the second device. In an optional implementation, the first device sends, to each second device, delete request information for deleting the first function configuration, to request each second device to delete the first function configuration. For example, as shown in FIG. 15, the first device is the DO/DC, and the second device is the DA. The DO/DC sends a first function configuration entry delete request to the DA, to request the DA to delete the first function configuration entry. After receiving the first function configuration entry delete request, and confirming that the first data processing operation on the first data is completed, the DA sends first function configuration entry delete confirmation to the DO/DC. After receiving the first function configuration entry delete confirmation, the DO/DC deletes the first function configuration entry.

In another optional implementation, the second device may send a first function configuration entry delete event to the first device, so that the first device deletes the first function configuration entry for the second device based on the first function configuration entry delete event. For example, as shown in FIG. 16, the first device is the DO/DC, and the second device is the DA. The DA sends the first function configuration entry delete event to the DO/DC, and the DO/DC receives the first function configuration entry delete event. The first function configuration entry delete event may be deleting a timer of the first function configuration entry, so that the DO/DC can periodically delete the first function configuration entry for the DA based on the timer.

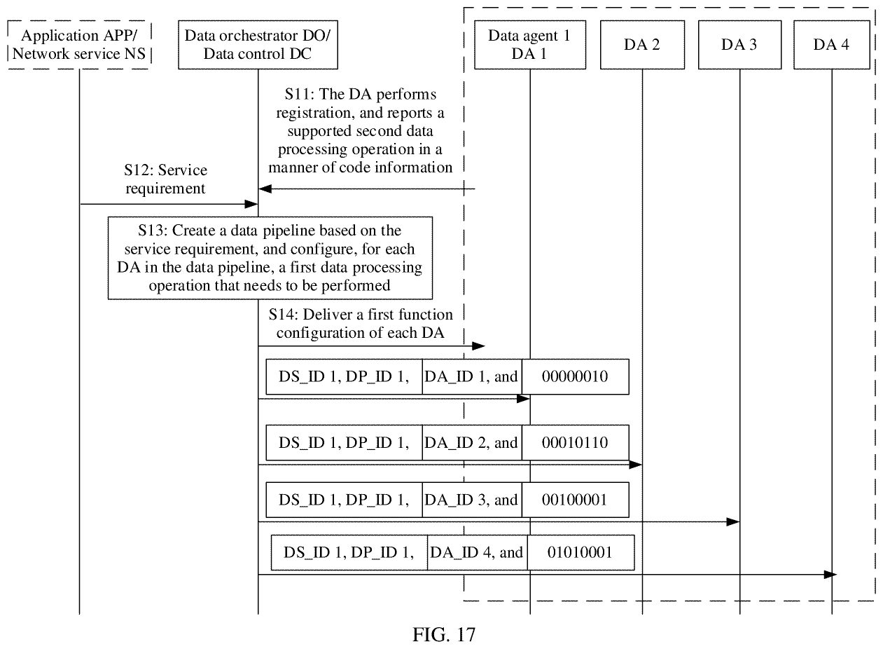

FIG. 17 is a diagram of an interaction procedure between an application (APP)/network service (NS), a DO/DC, and a DA existing when the first device is the DO/DC, the second device is the DA, a data pipeline 1 established by the DO/DC to support a service requirement includes a DA 1, a DA 2, a DA 3, and a DA 4, and first data processing operations that need to be performed by the DA 1, the DA 2, the DA 3, and the DA 4 in the data pipeline 1 are respectively data collection, data dimension reduction, data storage, and data analysis. As shown in FIG. 17, the interaction procedure between the application (APP)/network service (NS), the DO/DC, and the DA is shown as follows:

S11: Each of a plurality of DAs registers with the DO/DC, and reports a supported second data processing operation in a manner of code information.

That each of the plurality of DAs registers with the DO/DC may mean that each DA performs network registration and the like with the DO/DC. The second data processing operation supported by each DA may indicate a data service capability supported by the DA, and each DA may report the second data processing operation based on the code information. For example, the DA 1, the DA 2, the DA 3, and the DA 4 in FIG. 17 perform network registration with the DO/DC, and report the second data processing operation supported by each DA.

S12: The application (APP)/network service (NS) sends a service requirement to the DO/DC.

S13: The DO/DC creates a data pipeline based on the service requirement, and configures, for each DA in the data pipeline, a first data processing operation that needs to be performed.

For example, the data pipeline established by the DO/DC based on the service requirement includes the DA 1, the DA 2, the DA 3, and the DA 4 in FIG. 17, and the first data processing operations that need to be performed in the data pipeline and that are configured for the DA 1, the DA 2, the DA 3, and the DA 4 are respectively data collection, data dimension reduction, data storage, and data analysis.

S14: The DO/DC delivers a first function configuration of each DA.

The first function configuration of each DA includes an identifier of a data business, an identifier of the data pipeline, an identifier of the DA, and the first data processing operation that needs to be performed by the DA in the data pipeline.

For example, first function configurations delivered by the DO/DC to the DA 1, the DA 2, the DA 3, and the DA 4 are separately shown in FIG. 17. The first function configuration of the DA 1 includes DS_ID 1, DP_ID 1, DA_ID 1, and the code information 0000010 for performing data collection. The first function configuration of the DA 2 includes DS_ID 1, DP_ID 1, DA_ID 2, and the code information 00010110 for data dimension reduction. The first function configuration of the DA 3 includes DS_ID 1, DP_ID 1, DA_ID 3, and the code information 00100001 for performing data storage. The first function configuration of the DA 4 includes DS_ID 1, DP_ID 1, DA_ID 4, and the code information 01010001 for performing data analysis.

Therefore, the DA 1, the DA 2, the DA 3, and the DA 4 may learn of, based on the first function configuration of the DA 1, the DA 2, the DA 3, and the DA 4, the first data processing operations that need to be performed by the DA 1, the DA 2, the DA 3, and the DA 4 in the data pipeline for obtaining data for the service requirement, and may form, with reference to configured routing information and the like, a logical network covered in the network domain. This helps the DA 1, the DA 2, the DA 3, and the DA 4 sequentially perform the first data processing operations on the data when receiving source data obtained for the service requirement or first data obtained by processing the source data, to meet the service requirement.

In this embodiment of this application, the first device establishes the data pipeline supporting the service requirement, and configures, for each second device in the data pipeline, the first data processing operation that needs to be performed by the second device in the data pipeline. Therefore, the second devices in the data pipeline sequentially complete data processing when the service requirement is met. Therefore, each second device does not need to route, to another service node, the data including the identifier of the data business, and the another service node performs data processing on the data, thereby reducing a processing delay and a transmission bandwidth for data processing, and protecting data security and privacy.

In addition, in this embodiment of this application, as required, the first device establishes, based on the service requirement, the data pipeline and configures, the first data processing operation that needs to be performed by each second device in the data pipeline, so that the data pipeline and each second device in the data pipeline can be flexibly deployed as required, thereby meeting a flexible requirement of the service.

### 4. Data Processing Method 200

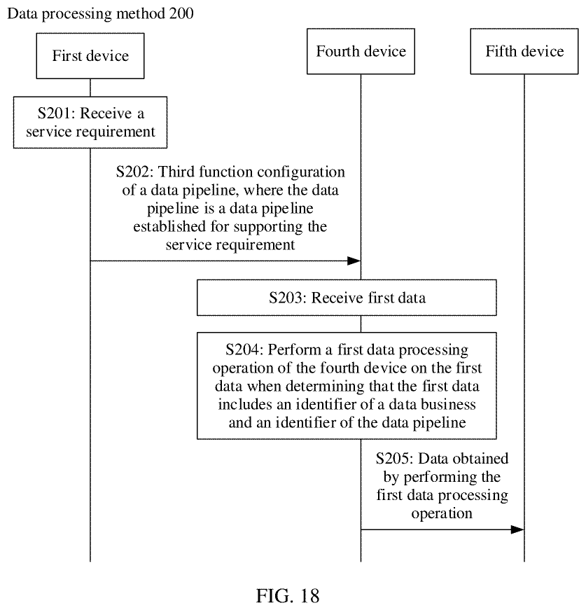

An embodiment of this application further provides a data processing method 200. FIG. 18 is a diagram of interaction of the data processing method 200. The data processing method 200 includes but is not limited to the following steps.

S201: A first device receives a service requirement.

For an implementation of S201, refer to the implementation of S101. Details are not described again.

In an optional implementation, the first device may further receive second data processing operations supported by a plurality of second devices, to obtain the second data processing operation supported by each second device.

Optionally, the first device may further receive geographical locations of the plurality of second devices, to learn of, based on the geographical locations of the second devices, a plurality of second devices within a management range of the first device.

For an implementation in which each of the plurality of second devices reports, to the first device, the second data processing operation supported by the second device and the geographical location of the second device, refer to the implementation of S101. Details are not described again.

S202: The first device sends a third function configuration of a data pipeline to a fourth device, where the data pipeline is a data pipeline established for supporting the service requirement. Correspondingly, the fourth device receives the third function configuration of the data pipeline.

The third function configuration includes a first data processing operation of each second device in the data pipeline, an identifier of the data pipeline, an identifier of a data business, and an address list. The first data processing operation is a data processing operation that needs to be performed by each second device in the data pipeline. The data business is determined based on the service requirement.

It may be understood that, after receiving the service requirement, the first device establishes, based on the second data processing operation supported by each second device, the data pipeline supporting the service requirement, and configures, for each second device, the first data processing operation that needs to be performed in the data pipeline.

It may also be understood that, after receiving the service requirement, the first device determines, from a second data processing operation supported by each second device, the data processing operation that needs to be performed by each second device in the data pipeline for the service requirement.

The fourth device is a second device serving as an ingress in the data pipeline. In other words, the fourth device is a 1^{st} second device that needs to perform the first data processing operation on first data in the data pipeline. For example, if the data pipeline includes a second device a, a second device b, and a second device c, and the second device a is the second device serving as the ingress in the data pipeline, the fourth device is the second device a.

The address list includes an address of a second device other than the fourth device in the data pipeline, and the address included in the address list is arranged in a ranking of performing a first data processing operation by the second device in the data pipeline. In other words, the first device further configures, in the first function configuration in the sequence of performing the first data processing operations by the second devices in the data pipeline, the addresses of the second devices other than the fourth device. In this manner, after performing the first data processing operation, the fourth device forwards, to a second device corresponding to a 1^{st} address in the address list, data obtained through processing, and then the second device forwards, to a second device corresponding to a next address in the address list, data obtained by processing the first data, so that the second devices in the data pipeline sequentially perform data processing on the first data.

For example, the first device is a DO, the second device is a DA, and third function configuration entries configured by the DO based on a service requirement 1 are shown in Table 16.

TABLE 16
Third function configuration entries

| | | Identifier | | First data | |
|---|---|---|---|---|---|
| Identifier | Identifier | of a | | processing | |
| of a data | of a data | fourth | Address | operations of the | |
| business | pipeline | device | list | second devices | Remark |
| DS_ID 1 | DP_ID 1 | DA_ID 1 | (add1, | 00000010, | (Ingress DA) Data |
| | | | add2, | 00010110, | collection->data |
| | | | and | 00100001, and | dimension reduction->data |
| | | | add3) | 01010001 | storage->big data analysis |

It can be seen from Table 16 that the fourth device in the data pipeline 1 configured by the DO is a DA 1 corresponding to DA_ID 1, and the first data processing operation of the DA 1 is the data collection. The addresses of the second devices after the fourth device are respectively add1, add2, and add3, and the first data processing operations of the second devices after the fourth device are respectively the data dimension reduction, the data storage, and the big data analysis.

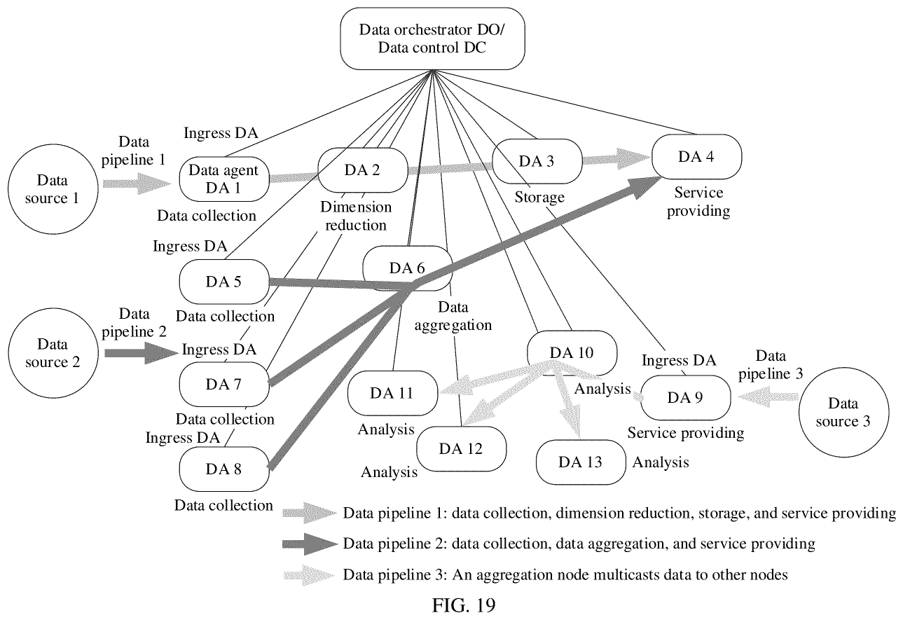

For example, the first device is a DO, the second device is a DA, and data pipelines established by the DO for a service requirement 1, a service requirement 2, and a service requirement 3 respectively are shown in FIG. 19. It can be learned from FIG. 19 that a data pipeline established by the DO to support the service requirement 1 is a data pipeline 1, the data pipeline 1 includes a DA 1, a DA 2, a DA 3, and a DA 4, and the DA 1 is an ingress DA in the data pipeline, that is, the DA 1 is a fourth device. In this case, the third function configuration that is of the data pipeline 1 and that is configured by the DO for the service requirement 1 includes an identifier of a data business 1 determined based on the service requirement 1, an identifier of the data pipeline 1, an identifier of the DA 1, an address list including addresses of the DA 2, the DA 3, and the DA 4, and a first data processing operation that needs to be performed by each of the DA 1, the DA 2, the DA 3, and the DA 4 in the data pipeline 1.

A data pipeline established by the DO for the service requirement 2 is a data pipeline 2. The data pipeline 2 includes a DA 5, a DA 6, and the DA 4, or includes a DA 7, the DA 6, and the DA 4, or includes a DA 8, the DA 6, and the DA 4. If the DA 5, the DA 7, or the DA 8 is an ingress DA in the data pipeline 2, the DA 5, the DA 7, or the DA 8 is a fourth device in the data pipeline 2.

Therefore, the third function configuration that is of the data pipeline 2 and that is configured by the DO for the service requirement 2 includes an identifier of a data business 2 determined based on the service requirement 2, an identifier of the data pipeline 2, an identifier of the DA 5, an address list including addresses of the DA 5, the DA 6, and the DA 4, and a first data processing operation that needs to be performed by each of the DA 5, the DA 6, and the DA 4 in the data pipeline 2. Alternatively, the third function configuration includes an identifier of data 2, an identifier of the data pipeline 2, an identifier of the DA 7, an address list including addresses of the DA 7, the DA 6, and the DA 4, and a first data processing operation that needs to be performed by each of the DA 7, the DA 6, and the DA 4 in the data pipeline 2. Alternatively, the third function configuration includes an identifier of data 2, an identifier of the data pipeline 2, an identifier of the DA 8, an address list including addresses of the DA 8, the DA 6, and the DA 4, and a first data processing operation that needs to be performed by each of the DA 8, the DA 6, and the DA 4 in the data pipeline 2.

A data pipeline established by the DO for the service requirement 3 is a data pipeline 3. The data pipeline 3 includes a DA 9, a DA 10, a DA 11, a DA 12, and a DA 13. The DA 9 is an ingress DA in the data pipeline 3, and the DA 9 is a fourth device in the data pipeline 3. Therefore, the third function configuration configured by the DO for the service requirement 3 includes an identifier of a data business 3 determined based on the service requirement 3, an identifier of the data pipeline 3, an identifier of the DA 9, an address list including addresses of the DA 9, the DA 10, the DA 11, the DA 12, and the DA 13, and a first data processing operation that needs to be performed by each of the DA 9, the DA 10, the DA 11, the DA 12, and the DA 13 in the data pipeline 3.

It can be learned that the first device may establish different data pipelines based on different service requirements. The first device may also establish, based on a same service requirement, different data pipelines including different second devices. The different data pipelines may include a same second device, and first data processing operations that need to be performed by the same second device in the different data pipelines are the same or different.

S203: The fourth device receives the first data.

S204: The fourth device performs a first data processing operation of the fourth device on the first data when determining that the first data includes the identifier of the data business and the identifier of the data pipeline.

That the first data includes the identifier of the data business and the identifier of the data pipeline may mean that a header of the first data carries the identifier of the data business and the identifier of the data pipeline.

When determining that the first data includes the identifier of the data business, the fourth device may determine that the first data is source data obtained based on the service requirement, or data obtained by processing the source data. When further determining that the first data includes the identifier of the data pipeline, the fourth device may determine the first data processing operation that needs to be performed on the first data. Therefore, the fourth device performs the first data processing operation of the fourth device on the first data when determining that the first data includes the identifier of the data business and the identifier of the data pipeline.

In addition, for an implementation in which the first data includes the identifier of the data pipeline, refer to the descriptions in S104. Details are not described again.

S205: The fourth device sends, to a fifth device, data obtained by performing the first data processing operation, where the fifth device is a second device corresponding to a 1^{st} address in the address list.

It may be understood that, after completing the first data processing operation on the first data, the fourth device forwards the obtained data to the second device corresponding to the 1^{st} address in the address list, that is, forwards the obtained data to a next second device that is in the data pipeline and that needs to perform the first data processing operation, namely, the fifth device. It may also be understood that an output of the fourth device is an input of the fifth device.

When the fourth device sends, to the fifth device, the data obtained by performing the first data processing operation, the data obtained through the first data processing operation carries the third function configuration, so that the fifth device can obtain, from the third function configuration, the first data processing operation that needs to be performed by the fifth device in the data pipeline.

After receiving the data from the fourth device, the fifth device determines whether the received data includes the identifier of the data business and the identifier of the data pipeline. If the received data includes the identifier of the data business and the identifier of the data pipeline, the fifth device performs, on the data from the fourth device, the first data processing operation that needs to be performed by the fifth device in the third function configuration, to obtain processed data.

In addition, the data obtained by performing the first data processing operation by the fifth device also carries the third function configuration. The fifth device may delete the address of the fifth device in the carried third function configuration, to obtain processed data, and then forward the processed data to a second device corresponding to a next address in the address list. This is sequentially performed, so that the second devices in the data pipeline sequentially complete processing on the source data obtained based on the service requirement, thereby meeting the service requirement.

For example, it can be learned from FIG. 19 that, for the service requirement 1, the fourth device is the DA 1, the fifth device is the DA 2, the DO/DC configures the third function configuration of the data pipeline 1 for the DA 1, and the DA 1 collects the data source 1 for the service requirement 1. Then, the DA 1 forwards the collected data source 1 to the DA 2. When determining that the received data includes the identifier of the data business 1 and the identifier of the data pipeline 1, the DA 2 performs, on the received data, the first data processing operation that needs to be performed by the DA 2 in the data pipeline 1, that is, performs dimension reduction on the received data, and deletes the address of the DA 2 carried in data obtained through dimension reduction, to obtain processed data. The DA 2 forwards the processed data to the device with the next address in the address list in the third function configuration, that is, forwards the processed data to the DA 3. When determining that the received data includes the identifier of the data business 1 and the identifier of the data pipeline 1, the DA 3 stores the received data, and deletes the address of the DA 3 carried in the stored data, to obtain stored data. Then, the DA 3 forwards the stored data to the device with the next address in the address list in the third function configuration, that is, forwards the stored data to the DA 4. When the received data includes the identifier of the data business 1 and the identifier of the data pipeline 1, the DA 4 provides a service for the received data. It can be learned that the DAs in the data pipeline 1 sequentially complete data processing on the data source 1 as required in an arrangement sequence of the DAs in the data pipeline 1, so that the service requirement 1 is met.

In an optional implementation, the first device may further send a second function configuration to a third device, where the second function configuration includes a third data processing operation. The third device is any second device in the data pipeline, and the third data processing operation is a data processing operation in the first data processing operation, or is a data processing operation other than the first data processing operation. For this implementation, refer to the implementation of S104. Details are not described again.

In this embodiment of this application, the first device establishes the data pipeline supporting the service requirement, configures, for each second device in the data pipeline, the first data processing operation that needs to be performed by the second device in the data pipeline, and the addresses at which the second devices sequentially perform the first data processing operations in the data pipeline, and sends the configuration to the second device (namely, the fourth device) serving as the ingress in the data pipeline. Therefore, when determining that the received first data includes the identifier of the data business and the identifier of the data pipeline, the fourth device performs, on the received first data, the first data processing operation corresponding to the fourth device, and forwards the processed data to the second device with the 1^{st} address in the address list. This further helps the second devices in the data pipeline sequentially complete data processing on the data in an address sequence in the address list.

It can be learned that, the second devices in the data pipeline may jointly complete data processing on the data based on the service requirement, without routing the data to another network node, and the another network node performs data processing on the data, thereby reducing a processing delay and a transmission bandwidth for data processing, and protecting data security and privacy.

In addition, the first device establishes, based on the service requirement, the data pipeline including the plurality of second devices, and configures, for each second device in the data pipeline, the first data processing that needs to be performed in the data pipeline, so that flexibility of the service can be met.

### 5. Data Processing Method 300

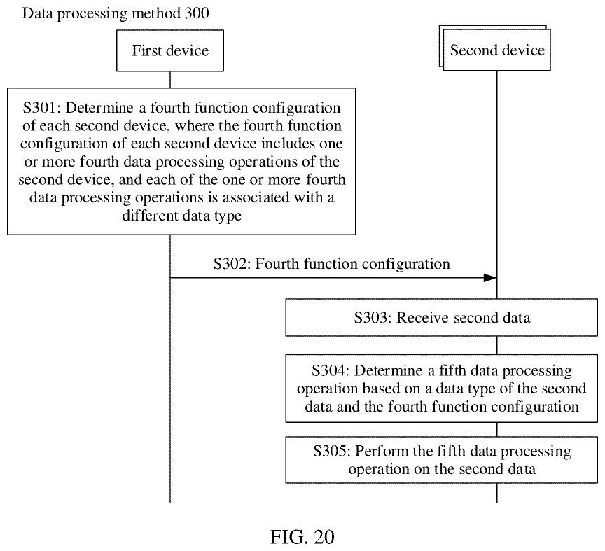

An embodiment of this application further provides a data processing method 300. FIG. 20 is a diagram of interaction of the data processing method 300. The data processing method 300 includes but is not limited to the following steps.

S301: A first device determines a fourth function configuration of each second device, where the fourth function configuration of each second device includes one or more fourth data processing operations of the second device, and each of the one or more fourth data processing operations is associated with a different data type.

The data type may be the data type in Table 1. For example, the data type may be one or more of the user data, the network AI data, the network data, and the IoT data.

It may be understood that the first device configures the fourth function configuration for each of a plurality of second devices, and the fourth function configuration of each second device includes the one or more fourth data processing operations associated with different data types. This helps the second device determine, based on a data type of received data, a data processing operation to be performed on the received data.

For example, the fourth function configuration configured by the first device for a second device a includes: user data and data collection, data cleaning, and data storage that need to be performed on the user data, and network data and data collection, data filtering, and differential privacy that need to be performed on the network data.

Optionally, the first device configures a same fourth data processing operation for the plurality of second devices for data of a same type. For example, the first device is a DO, and the second device includes a DA 1, a DA 2, and a DA 3. For data which is IoT data in data type, fourth data processing operations configured by the DO for the DA 1, the DA 2, and the DA 3 are all data cleaning. In this case, when any one of the DA 1, the DA 2, and the DA 3 receives the IoT data, the DA performs data cleaning on the IoT data by default.

In an optional implementation, the plurality of second devices may report, to the first device, second data processing operations supported by the second devices, so that the first device receives the second data processing operations supported by the plurality of second devices. In this manner, the first device learns of the second data processing operation supported by each second device.

Optionally, the plurality of second devices may further report geographical locations of the second devices to the first device, so that the first device learns of a second device within a management range of the first device.

For an implementation in which the second device reports the second data processing operation and the geographical location to the first device, refer to S101. Details are not described again.

S302: The first device sends the corresponding fourth function configuration to each second device. Correspondingly, each second device receives the fourth function configuration.

S303: The second device receives second data.

S304: The second device determines a fifth data processing operation based on a data type of the second data and the fourth function configuration.

The one or more fourth data processing operations configured in the fourth function configuration are associated with the data type. Therefore, the second device may determine, from the fourth function configuration based on the data type of the second data, the fifth data processing operation that needs to be performed on the second data, to improve reliability of performing data processing on the second data.

S305: The second device performs the fifth data processing operation on the second data.

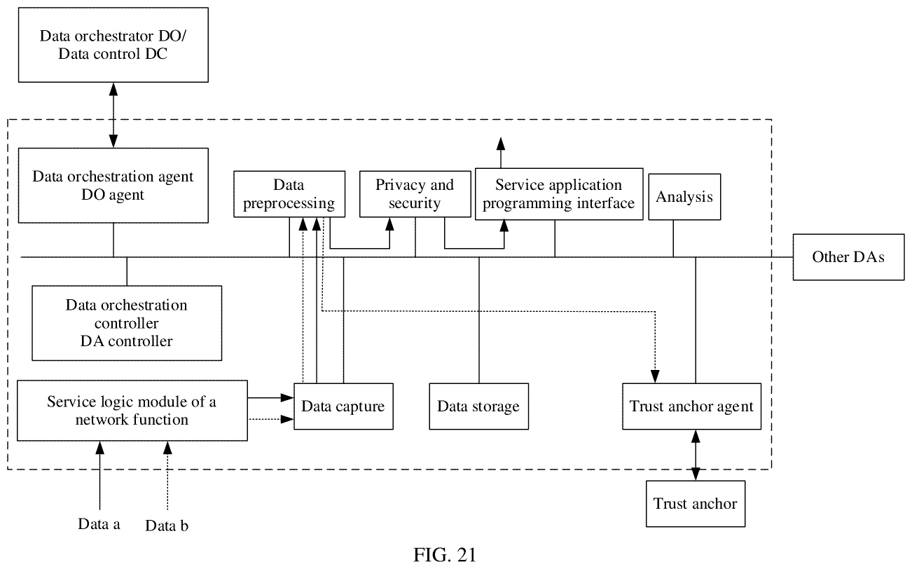

For example, this embodiment of this application is applicable to a scenario in which a DO/DC is combined with a DA controller shown in FIG. 21. As shown in FIG. 21, a DA includes a DO agent, a DA controller, and a service logic module of an NF. The DO/DC may configure the fourth function configuration for the DA, where the fourth data processing operation in the fourth function configuration is associated with the data type of the data. Therefore, after obtaining the data, the service logic module in the DA performs the corresponding data processing operation on the data based on the data type of the data. For example, as shown in FIG. 21, after obtaining data a, the service logic module of the NF sequentially performs data capture (data capture), data preprocessing (data preprocessing), privacy and security (privacy & security), and service application programming interface (service API) on the data a based on a data type of the data a. For another example, as shown in FIG. 21, after obtaining data b, the service logic module of the NF sequentially performs data capture, data preprocessing, and security authentication on the data b based on a data type of the data b. In FIG. 13, a solid-line unidirectional arrow indicates a flow direction of the data a, and a dashed-line unidirectional arrow indicates a flow direction of the data b.

In this embodiment of this application, the first device configures, for each second device, the fourth data processing operation associated with the different data type, so that each second device may determine, based on the data type of the received data, the fifth data processing operation to be performed on the received data, and does not need to forward the received data to another device for data processing, so that a processing delay of data processing can be reduced.

### 6. Apparatus

To implement functions in the methods provided in embodiments of this application, the first device, the second device, and the fourth device may include a hardware structure and/or a software module, and implement the functions in a form of the hardware structure, the software module, or a combination of the hardware structure and the software module. Whether a function in the functions is performed by the hardware structure, the software module, or the combination of the hardware structure and the software module depends on particular applications and design constraints of the technical solutions.

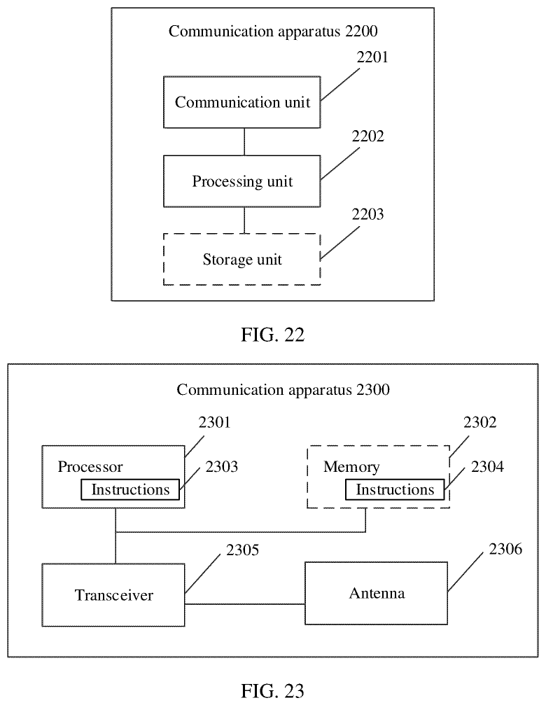

As shown in FIG. 22, an embodiment of this application provides a communication apparatus 2200. The communication apparatus 2200 may be a component (for example, an integrated circuit or a chip) of a first device, may be a component (for example, an integrated circuit or a chip) of a second device, or may be a component (for example, an integrated circuit or a chip) of a fourth device, and is configured to implement the methods in the method embodiments of this application. The communication apparatus 2200 may include a communication unit 2201 and a processing unit 2202. Optionally, the communication apparatus 2200 may further include a storage unit 2203.

In a possible design, one or more units in FIG. 22 may be implemented by one or more processors, implemented by one or more processors and memories, implemented by one or more processors and transceivers, or implemented by one or more processors, memories, and transceivers. This is not limited in embodiments of this application. The processor, the memory, and the transceiver may be disposed separately, or may be integrated.

The communication apparatus 2200 has a function of implementing the first device, the second device, or the fourth device described in embodiments of this application. For example, the communication apparatus 2200 includes a module, a unit, or a means (means) corresponding to a first device performing the steps related to a transmit end described in embodiments of this application. The function, the unit, or the means (means) may be implemented by software or hardware, may be implemented by hardware executing corresponding software, or may be implemented by a combination of software and hardware. For details, refer to the corresponding descriptions in the foregoing corresponding method embodiments.

In a possible design, a communication apparatus 2200 may include a processing unit 2202 and a communication unit 2201. The processing unit 2202 is configured to control the communication unit 2201 to receive and send data/signaling.

The communication unit 2201 is configured to receive a service requirement; and
the communication unit 2201 is further configured to send a first function configuration of each second device in a data pipeline, where
the data pipeline is a data pipeline established for supporting the service requirement, the first function configuration of each second device includes an identifier of a data business, an identifier of the data pipeline, and a first data processing operation, the first data processing operation is a data processing operation that needs to be performed by each second device in the data pipeline, and the data business is determined based on the service requirement.

In an optional implementation, the first function configuration of each second device further includes one or more addresses, and an output of each second device is input of one or more devices at the one or more addresses corresponding to the second device.

In an optional implementation, the communication unit 2201 is further configured to: receive second data processing operations supported by a plurality of second devices; and determine, by the first device from a second data processing operation supported by each second device, the data processing operation that needs to be performed by each second device in the data pipeline for the service requirement.

In an optional implementation, the communication unit 2201 is further configured to send a second function configuration to a third device, where the second function configuration includes a third data processing operation, the third device is any second device in the data pipeline, and the third data processing operation is a data processing operation in the first data processing operation, or is a data processing operation other than the first data processing operation.

This embodiment of this application and the foregoing method embodiments are based on a same concept, and bring same technical effect. For a specific principle, refer to the descriptions of the foregoing embodiments. Details are not described again.

In another possible design, a communication apparatus 2200 may include a processing unit 2202 and a communication unit 2201.

The communication unit 2201 is configured to receive a first function configuration, where the first function configuration includes an identifier of a data business, an identifier of a data pipeline, and a first data processing operation, the data pipeline is a data pipeline established for supporting a service requirement, the first data processing operation is a data processing operation that needs to be performed by the second device in the data pipeline, and the data business is determined based on the service requirement;
the communication unit 2201 is further configured to receive first data; and
the processing unit 2202 is configured to perform the first data processing operation on the first data when determining that the first data includes the identifier of the data business and the identifier of the data pipeline.

In an optional implementation, the first function configuration further includes one or more addresses, and an output of the second device is input of one or more devices at the one or more addresses.

In an optional implementation, the communication unit 2201 is further configured to send, to the device with the one or more addresses, data obtained by performing the first data processing operation.

In an optional implementation, the communication unit 2201 is further configured to send, to a first device, a second data processing operation supported by the second device, where the first data processing operation of the second device is the data processing operation that is in the second data processing operation supported by the second device and that needs to be performed by the second device in the data pipeline for the service requirement.

In an optional implementation, the communication unit 2201 is further configured to receive a second function configuration, where the second function configuration includes a third data processing operation, where the third data processing operation is a data processing operation in the first data processing operation, or is a data processing operation other than the first data processing operation, and the processing unit 2202 is further configured to update, based on the third data processing operation, the data processing operation that needs to be performed in the data pipeline.

This embodiment of this application and the foregoing method embodiments are based on a same concept, and bring same technical effect. For a specific principle, refer to the descriptions of the foregoing embodiments. Details are not described again.

In still another possible design, a communication apparatus 2200 may include a processing unit 2202 and a communication unit 2201. The processing unit 2202 is configured to control the communication unit 2201 to receive and send data/signaling.

The communication unit 2201 is configured to receive a service requirement;
the communication unit 2201 is further configured to send a third function configuration of a data pipeline to a fourth device, where the data pipeline is a data pipeline established for supporting the service requirement;
the third function configuration includes a first data processing operation of each second device in the data pipeline, an identifier of the data pipeline, an identifier of a data business, and an address list, and the data business is determined based on the service requirement;
the first data processing operation is a data processing operation that needs to be performed by each second device in the data pipeline; and
the address list includes an address of a second device other than the fourth device in the data pipeline, and the address included in the address list is arranged in a ranking of performing a first data processing operation by the second device in the data pipeline, and the fourth device is a second device serving as an ingress in the data pipeline.

In an optional implementation, the communication unit 2201 is further configured to receive second data processing operations supported by a plurality of second devices; and
determine, by the first device from a second data processing operation supported by each second device, the data processing operation that needs to be performed by each second device in the data pipeline for the service requirement.

In an optional implementation, the communication unit 2201 is further configured to send a second function configuration to a third device, where the second function configuration includes a third data processing operation, the third device is any second device in the data pipeline, and the third data processing operation is a data processing operation in the first data processing operation, or is a data processing operation other than the first data processing operation.

This embodiment of this application and the foregoing method embodiments are based on a same concept, and bring same technical effect. For a specific principle, refer to the descriptions of the foregoing embodiments. Details are not described again.

In still another possible design, a communication apparatus 2200 may include the processing unit 2202 and the communication unit 2201.

The communication unit 2201 is configured to receive a third function configuration of a data pipeline, where the third function configuration includes a first data processing operation of each second device in the data pipeline, an identifier of the data pipeline, an identifier of a data business, and an address list, the data pipeline is a data pipeline established for supporting a service requirement, and the data business is determined based on the service requirement, where
the first data processing operation is a data processing operation that needs to be performed by each second device in the data pipeline, the address list includes an address of a second device other than a fourth device in the data pipeline, and the address included in the address list is arranged in a ranking of performing a first data processing operation by the second device in the data pipeline;
the communication unit 2201 is further configured to receive first data;
the processing unit 2202 is configured to perform a first data processing operation of the fourth device on the first data when determining that the first data includes the identifier of the data business and the identifier of the data pipeline; and
the communication unit 2201 is further configured to send, to a fifth device, data obtained by performing the first data processing operation, where the fifth device is a second device corresponding to a 1^{st} address in the address list.

In an optional implementation, the communication unit 2201 is further configured to send, to a first device, a second data processing operation supported by the fourth device, where the first data processing operation of the fourth device is a data processing operation that is in the second data processing operation supported by the fourth device and that needs to be performed by the fourth device in the data pipeline for the service requirement.

In an optional implementation, the communication unit 2201 is further configured to receive a second function configuration, where the second function configuration includes a third data processing operation; where the third data processing operation is a data processing operation in the first data processing operation of the fourth device, or is a data processing operation other than the first data processing operation of the fourth device; and the processing unit 2202 is further configured to update, based on the third data processing operation, the data processing operation that needs to be performed in the data pipeline.

This embodiment of this application and the foregoing method embodiments are based on a same concept, and bring same technical effect. For a specific principle, refer to the descriptions of the foregoing embodiments. Details are not described again.

In still another possible design, a communication apparatus 2200 may include a processing unit 2202 and a communication unit 2201.

The processing unit 2202 is configured to determine a fourth function configuration of each second device, where the fourth function configuration of each second device includes one or more fourth data processing operations of the second device, and each of the one or more fourth data processing operations is associated with a different data type; and
the communication unit 2201 is configured to send the corresponding fourth function configuration to each second device.

In an optional implementation, the communication unit 2201 is further configured to receive second data processing operations supported by a plurality of second devices.

In an optional implementation, the one or more fourth data processing operations of each second device are determined based on the second data processing operation supported by the second device.

This embodiment of this application and the foregoing method embodiments are based on a same concept, and bring same technical effect. For a specific principle, refer to the descriptions of the foregoing embodiments. Details are not described again.

In still another possible design, a communication apparatus 2200 may include a processing unit 2202 and a communication unit 2201.

The communication unit 2201 is configured to receive a fourth function configuration, where
the fourth function configuration includes one or more fourth data processing operations of the second device, and each of the one or more fourth data processing operations is associated with a different data type.

In an optional implementation, the communication unit 2201 is further configured to receive second data; the processing unit 2202 is configured to determine a fifth data processing operation based on a data type of the second data and the fourth function configuration; and the second device performs the fifth data processing operation on the second data.

In an optional implementation, the communication unit 2201 is further configured to send, to a first device, a second data processing operation supported by the second device.

This embodiment of this application and the foregoing method embodiments are based on a same concept, and bring same technical effect. For a specific principle, refer to the descriptions of the foregoing embodiments. Details are not described again.

An embodiment of this application further provides a communication apparatus 2300. FIG. 23 is a diagram of a structure of the communication apparatus 2300. The communication apparatus 2300 may be a first device, or may be a chip, a chip system, a processor, or the like that supports a first device in implementing the foregoing method. Alternatively, the communication apparatus 2300 may be a second device, or may be a chip, a chip system, a processor, or the like that supports a second device in implementing the foregoing method. The communication apparatus 2300 may be a fourth device, or may be a chip, a chip system, a processor, or the like that supports a fourth device in implementing the foregoing method. The apparatus may be configured to implement the methods described in the foregoing method embodiments. For details, refer to the descriptions in the foregoing method embodiments.

The communication apparatus 2300 may include one or more processors 2301. The processor 2301 may be a general-purpose processor, a dedicated processor, or the like, for example, the processor may be a baseband processor, a digital signal processor, an application-specific integrated circuit, a field programmable gate array or another programmable logic device, a discrete gate or a transistor logic device, a discrete hardware component, or a central processing unit (central processing unit, CPU). The baseband processor may be configured to process a communication protocol and communication data. The central processing unit may be configured to control the communication apparatus (for example, a base station, a baseband chip, a terminal, a terminal chip, a distributed unit (distributed unit, DU), or a central unit (central unit, CU)), execute a software program, and process data of the software program.

Optionally, the communication apparatus 2300 may include one or more memories 2302, where the memory stores instructions 2304. The instructions may be run on the processor 2301, so that the communication apparatus 2300 performs the methods described in the foregoing method embodiments. Optionally, the memory 2302 may further store data. The processor 2301 and the memory 2302 may be separately disposed, or may be integrated together.

The memory 2302 may include but is not limited to a non-volatile memory like a hard disk drive (hard disk drive, HDD) or a solid-state drive (solid-state drive, SSD), a random access memory (Random Access Memory, RAM), an erasable programmable read-only memory (Erasable Programmable ROM, EPROM), a ROM, a portable read-only memory (Compact Disc Read-Only Memory, CD-ROM), or the like.

Optionally, the communication apparatus 2300 may further include a transceiver 2305 and an antenna 2306. The transceiver 2305 may be referred to as a transceiver unit, a transceiver machine, a transceiver circuit, or the like, and is configured to implement a transceiver function. The transceiver 2305 may include a receiver and a transmitter. The receiver may be referred to as a receiver machine, a receiver circuit, or the like, and is configured to implement a receiving function. The transmitter may be referred to as a transmitter machine, a transmitter circuit, or the like, and is configured to implement a sending function.

When the communication apparatus 2300 is a first device, the transceiver 2305 is configured to perform S102 in the data processing method 100, S201 and S202 in the data processing method 200, and S302 in the data processing method 300; and the processor 2301 is configured to perform S101 in the data processing method 100, S201 in the data processing method 200, and S301 in the data processing method 300.

When the communication apparatus 2300 is a second device, the transceiver 2305 is configured to perform S102 and S103 in the data processing method 100 and S302 and S303 in the data processing method 300; and the processor 2301 is configured to perform S104 in the data processing method 100 and S304 and S305 in the data processing method 300.

When the communication apparatus 2300 is a fourth device, the transceiver 2305 is configured to perform S202, S203, and S205 in the data processing method 200; and the processor 2301 is configured to perform S204 in the data processing method 200.

In another possible design, the processor 2301 may include a transceiver configured to implement receiving and sending functions. For example, the transceiver may be a transceiver circuit, an interface, or an interface circuit. The transceiver circuit, the interface, or the interface circuit configured to implement the receiving and sending functions may be separated, or may be integrated together. The transceiver circuit, the interface, or the interface circuit may be configured to read and write code/data. Alternatively, the transceiver circuit, the interface, or the interface circuit may be configured to transmit or transfer a signal.

In still another possible design, optionally, the processor 2301 may store instructions 2303, and the instructions 2303 are run on the processor 2301, to enable the communication apparatus 2300 to perform the methods described in the foregoing method embodiments. The instructions 2303 may be fixed in the processor 2301. In this case, the processor 2301 may be implemented by hardware.

In still another possible design, the communication apparatus 2300 may include a circuit, and the circuit may implement a sending, receiving, or communication function in the foregoing method embodiments. The processor and the transceiver described in embodiments of this application may be implemented on an integrated circuit (integrated circuit, IC), an analog IC, a radio frequency integrated circuit (radio frequency integrated circuit, RFIC), a mixed-signal IC, an application-specific integrated circuit (application-specific integrated circuit, ASIC), a printed circuit board (printed circuit board, PCB), an electronic device, or the like. The processor and the transceiver may alternatively be manufactured by using various IC process technologies, for example, a complementary metal oxide semiconductor (complementary metal oxide semiconductor, CMOS), an N-type metal oxide semiconductor (nMetal-oxide-semiconductor, NMOS), a P-type metal oxide semiconductor (positive channel metal oxide semiconductor, PMOS), a bipolar junction transistor (Bipolar Junction Transistor, BJT), a bipolar CMOS (BiCMOS), silicon germanium (SiGe), and gallium arsenide (GaAs).

A scope of the communication apparatus described in embodiments of this application is not limited thereto, and the structure of the communication apparatus may not be limited by FIG. 23. The communication apparatus may be an independent device or may be a part of a large device. For example, the communication apparatus may be:
(1) an independent integrated circuit IC, a chip, or a chip system or subsystem;
(2) a set having one or more ICs, and optionally, the IC set may also include a storage component configured to store data and instructions;
(3) an ASIC, for example, a modem (modulator); and
(4) a module that can be embedded in another device.

The communication apparatus and the chip in this embodiment of this application may further perform the implementation of the communication apparatus 2200. A person skilled in the art may further understand that various illustrative logical blocks (illustrative logic block) and steps (step) that are listed in embodiments of this application may be implemented by using electronic hardware, computer software, or a combination thereof. Whether the functions are implemented by hardware or software depends on particular applications and design requirements of the entire system. A person skilled in the art may use various methods to implement the described functions for each particular application, but it should not be considered that this implementation goes beyond the scope of embodiments of this application.

This embodiment of this application and the method embodiments shown in the data processing method 100 to the data processing method 300 are based on a same concept, and bring same technical effect. For a specific principle, refer to the descriptions of the foregoing embodiments shown in the data processing method 100 to the data processing method 300. Details are not described again.

This application further provides a computer-readable storage medium, configured to store computer software instructions. When the instructions are executed by a communication apparatus, the function in any one of the foregoing method embodiments is implemented.

This application further provides a computer program product, configured to store computer software instructions. When the instructions are executed by a communication apparatus, the function in any one of the foregoing method embodiments is implemented.

This application further provides a computer program. When the computer program is run on a computer, the function in any one of the foregoing method embodiments is implemented.

This application further provides a communication system. The system includes one or more network devices and one or more terminal devices. In another possible design, the system may further include another device that interacts with the network device and the terminal device in the solutions provided in this application.

All or some of the foregoing embodiments may be implemented by software, hardware, firmware, or any combination thereof. When software is used to implement the embodiments, all or some of the embodiments may be implemented in a form of a computer program product. The computer program product includes one or more computer instructions. When the computer instructions are loaded and executed on a computer, the procedures or functions according to embodiments of this application are all or partially generated. The computer may be a general-purpose computer, a dedicated computer, a computer network, or another programmable apparatus. The computer instructions may be stored in a computer-readable storage medium, or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (digital subscriber line, DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk drive, or a magnetic tape), an optical medium (for example, a high-density digital video disc (digital video disc, DVD)), a semiconductor medium (for example, an SSD), or the like.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A data processing method at a first device, wherein the method comprises:
receiving a service requirement; and
sending a first function configuration of each second device in a data pipeline, wherein the data pipeline is a data pipeline established for supporting the service requirement; and
the first function configuration of each second device comprises an identifier of a data business, an identifier of the data pipeline, and a first data processing operation, wherein
the data business is determined based on the service requirement, and
the first data processing operation is a data processing operation to be performed by the second device in the data pipeline.

2. The method according to claim 1, wherein
the first function configuration of each second device further comprises one or more addresses; and
an output of each second device is input to one or more devices at the one or more addresses corresponding to the second device.

3. The method according to claim 1, wherein the method further comprises:
receiving second data processing operations supported by a plurality of second devices; and
determining from the second data processing operation supported by each second device, the data processing operation to be performed by each second device in the data pipeline for the service requirement.

4. The method according to claim 1, wherein the method further comprises:
sending a second function configuration to a third device, wherein
the second function configuration comprises a third data processing operation;
the third device is any second device in the data pipeline; and
the third data processing operation is a data processing operation in the first data processing operation, or is a data processing operation other than the first data processing operation.

5. A data processing method at a second device, wherein the method comprises:
receiving a first function configuration, wherein
the first function configuration comprises an identifier of a data business, an identifier of a data pipeline, and a first data processing operation,
the data pipeline is a data pipeline established for supporting a service requirement,
the data business is determined based on the service requirement, and
the first data processing operation is a data processing operation to be performed by the second device in the data pipeline;
receiving first data; and
performing the first data processing operation on the first data in response to determining that the first data comprises the identifier of the data business and the identifier of the data pipeline.

6. The method according to claim 5, wherein
the first function configuration further comprises one or more addresses; and
an output of the second device is input to one or more devices at the one or more addresses.

7. The method according to claim 6, wherein the method further comprises:
sending, to the one or more devices at the one or more addresses, data obtained by performing the first data processing operation.

8. The method according to claim 5, wherein the method further comprises:
sending, to a first device, a second data processing operation supported by the second device, wherein
the first data processing operation to be performed by the second device in the data pipeline for the service requirement is included in the second data processing operation supported by the second device.

9. The method according to claim 5, wherein the method further comprises:
receiving a second function configuration, wherein
the second function configuration comprises a third data processing operation, and
the third data processing operation is a data processing operation in the first data processing operation, or is a data processing operation other than the first data processing operation; and
updating, based on the third data processing operation, the data processing operation to be performed in the data pipeline.

10. A communication apparatus, comprising: at least one processor coupled to at least one memory storing a computer program including instructions that are executable by the at least one processor to cause the communication apparatus to perform:
receiving a service requirement; and
sending a first function configuration of each second device in a data pipeline, wherein
the data pipeline is a data pipeline established for supporting the service requirement; and
the first function configuration of each second device comprises an identifier of a data business, an identifier of the data pipeline, and a first data processing operation, wherein
the data business is determined based on the service requirement, and
the first data processing operation is a data processing operation to be performed by the second device in the data pipeline.

11. The communication apparatus according to claim 10, wherein
the first function configuration of each second device further comprises one or more addresses; and
an output of each second device is input to one or more devices at the one or more addresses corresponding to the second device.

12. The communication apparatus according to claim 10, wherein the instructions are executable by the processor to further cause the communication apparatus to perform:
receiving second data processing operations supported by a plurality of second devices; and
determining from the second data processing operation supported by each second device, the data processing operation to be performed by each second device in the data pipeline for the service requirement.

13. The communication apparatus according to claim 10, wherein the instructions are executable by the processor to further cause the communication apparatus to perform:
sending a second function configuration to a third device, wherein
the second function configuration comprises a third data processing operation;
the third device is any second device in the data pipeline; and
the third data processing operation is a data processing operation in the first data processing operation, or is a data processing operation other than the first data processing operation.

14. A communication apparatus, comprising: at least one processor coupled to at least one memory storing a computer program including instructions that are executable by the at least one processor to cause the communication apparatus to perform:
receiving a first function configuration, wherein
the first function configuration comprises an identifier of a data business, an identifier of a data pipeline, and a first data processing operation,
the data pipeline is a data pipeline established for supporting a service requirement,
the data business is determined based on the service requirement, and
the first data processing operation is a data processing operation to be performed by the communication apparatus in the data pipeline;
receiving first data; and
performing the first data processing operation on the first data in response to determining that the first data comprises the identifier of the data business and the identifier of the data pipeline.

15. The communication apparatus according to claim 14, wherein
the first function configuration further comprises one or more addresses; and
an output of the communication apparatus is input to one or more devices at the one or more addresses.

16. The communication apparatus according to claim 15, wherein the instructions are executable by the processor to further cause the communication apparatus to perform:
sending, to the one or more devices at the one or more addresses, data obtained by performing the first data processing operation.

17. The communication apparatus according to claim 14, wherein the instructions are executable by the processor to further cause the communication apparatus to perform:
sending, to a first device, a second data processing operation supported by the communication apparatus, wherein
the first data processing operation to be performed by the communication apparatus in the data pipeline for the service requirement is included in the second data processing operation supported by the communication apparatus.

18. The communication apparatus according to claim 14, wherein the instructions are executable by the processor to further cause the communication apparatus to perform:
receiving a second function configuration, wherein
the second function configuration comprises a third data processing operation, and
the third data processing operation is a data processing operation in the first data processing operation, or is a data processing operation other than the first data processing operation; and
updating, based on the third data processing operation, the data processing operation to be performed in the data pipeline.

19. The method according to claim 9, wherein
in response to the third data processing operation being in the first data processing operation,
the updating comprises deleting the third data processing operation in the first data processing operation.

20. The method according to claim 9, wherein
in response to the third data processing operation being other than the first data processing operation,
the updating comprises adding the third data processing operation based on the first data processing operation.
